(19) United States
(12) Patent Application Publication
(10) Pub. No.: US 2025/0247566 A1
(43) Pub. Date: Jul. 31, 2025

(54) ENCODING METHOD, DECODING METHOD, CODE STREAM, ENCODER, DECODER AND STORAGE MEDIUM

(71) Applicant: GUANGDONG OPPO MOBILE TELECOMMUNICATIONS CORP., LTD., Dongguan (CN)

(72) Inventors: Fuzheng YANG, Dongguan (CN); Junyan HUO, Dongguan (CN); Yanzhuo MA, Dongguan (CN); Ming LI, Dongguan (CN)

(73) Assignee: GUANGDONG OPPO MOBILE TELECOMMUNICATIONS CORP., LTD., Dongguan (CN)

(21) Appl. No.: 19/183,105

(22) Filed: Apr. 18, 2025

Related U.S. Application Data
(63) Continuation of application No. PCT/CN2022/126028, filed on Oct. 18, 2022.

(51) Int. Cl. H04N 19/70; H04N 19/103; H04N 19/597

(52) U.S. Cl. CPC H04N 19/70; H04N 19/103; H04N 19/597

(57) ABSTRACT

The embodiments of the present application disclose an encoding method, a decoding method, a code stream, an encoder, a decoder and a storage medium. The decoding method comprises: on the basis of a first preset condition, determining a candidate data processing mode; determining a data processing mode parameter corresponding to a syntax element to be decoded; on the basis of the candidate data processing mode, determining a target data processing mode according to the data processing mode parameter, and decoding said syntax element according to the target data processing mode, and determining the value of said syntax element.

### CROSS-REFERENCE TO RELATED APPLICATIONS

This application is a continuation of International Application No. PCT/CN2022/126028, filed on Oct. 18, 2022, the disclosure of which is hereby incorporated by reference in its entirety.

### TECHNICAL FIELD

Embodiments of this application relate to the field of point cloud coding technologies, and in particular, to an encoding/decoding method, a bitstream, an encoder, a decoder, and a storage medium.

### BACKGROUND

In a coding framework of geometry-based point cloud compression (Geometry-based Point Cloud Compression, G-PCC), geometric information of a point cloud and attribute information corresponding to a point in the point cloud are separately encoded. In the G-PCC coding framework, geometry coding mainly includes octree geometry coding or predictive geometry coding.

In a related technology, information about some parameters of an encoder is improperly set, and both a probability value of the encoder and an index mapping table need to be updated, making it difficult to select a most matched encoder for encoding in an encoding process, thereby reducing coding efficiency.

### SUMMARY

Embodiments of this application provide an encoding/decoding method, a bitstream, an encoder, a decoder, and a storage medium, which can reduce a code rate and improve coding efficiency, thereby improving coding performance.

Technical solutions in embodiments of this application may be implemented as follows.

According to a first aspect, an embodiment of this application provides a decoding method, applied to a decoder, and method includes:
determining candidate data processing modes based on a first preset condition;
determining a data processing mode parameter corresponding to a to-be-decoded syntax element;
determining a target data processing mode based on the candidate data processing modes and the data processing mode parameter; and
decoding the to-be-decoded syntax element based on the target data processing mode to determine a value of the to-be-decoded syntax element.

According to a second aspect, an embodiment of this application provides an encoding method, applied to an encoder, and the method includes:
determining candidate data processing modes based on a first preset condition;
determining a data processing mode parameter corresponding to a to-be-encoded syntax element;
determining a target data processing mode based on the candidate data processing modes and the data processing mode parameter; and
encoding a value of the to-be-encoded syntax element based on the target data processing mode, and writing the encoded value into a bitstream.

According to a third aspect, an embodiment of this application provides a bitstream, and the bitstream is generated by performing bit encoding on to-be-encoded information. The to-be-encoded information includes at least a value of to-be-encoded syntax element.

According to a fourth aspect, an embodiment of this application provides an encoder, and the encoder includes a first determining unit and an encoding unit.

The first determining unit is configured to: determine candidate data processing modes based on a first preset condition, and determine a data processing mode parameter corresponding to a to-be-encoded syntax element.

The first determining unit is further configured to determine a target data processing mode based on the candidate data processing modes and the data processing mode parameter.

The encoding unit is configured to: encode a value of the to-be-encoded syntax element based on the target data processing mode, and write the encoded value into a bitstream.

According to a fifth aspect, an embodiment of this application provides an encoder, and the encoder includes a first memory and a first processor.

The first memory is configured to store a computer program runnable on the first processor.

The first processor is configured to run the computer program to execute the method according to the second aspect.

According to a sixth aspect, an embodiment of this application provides a decoder, and the decoder includes a second determining unit and a decoding unit.

The second determining unit is configured to: determine candidate data processing modes based on a first preset condition, and determine a data processing mode parameter corresponding to a to-be-decoded syntax element.

The second determining unit is further configured to determine a target data processing mode based on the candidate data processing modes and the data processing mode parameter.

The decoding unit is configured to decode the to-be-decoded syntax element based on the target data processing mode to determine a value of the to-be-decoded syntax element.

According to a seventh aspect, an embodiment of this application provides a decoder, and the decoder includes a second memory and a second processor.

The second memory is configured to store a computer program runnable on the second processor.

The second processor is configured to run the computer program to execute the method according to the first aspect.

According to an eighth aspect, an embodiment of this application provides a computer-readable storage medium, where the computer-readable storage medium stores a computer program, and the computer program is executed to implement the method according to the first aspect or the method according to the second aspect.

Embodiments of this application provide an encoding/decoding method, a bitstream, an encoder, a decoder, and a storage medium. On an encoding side, candidate data processing modes is determined based on a first preset condition; a data processing mode parameter corresponding to a to-be-encoded syntax element is determined; a target data processing mode is determined based on the candidate data processing modes and the data processing mode parameter; and a value of the to-be-encoded syntax element is encoded based on the target data processing mode, and the encoded value is written into a bitstream. On a decoding side, candidate data processing modes is determined based on a first preset condition; a data processing mode parameter corresponding to a to-be-decoded syntax element is determined; a target data processing mode is determined based on the candidate data processing modes and the data processing mode parameter; and the to-be-decoded syntax element is decoded based on the target data processing mode, to determine a value of the to-be-decoded syntax element.

### BRIEF DESCRIPTION OF DRAWINGS

FIG. 1 is a schematic diagram of a network architecture of point cloud coding.

FIG. 2 is a schematic diagram of a framework of a G-PCC encoder.

FIG. 3 is a schematic diagram of a framework of a G-PCC decoder.

FIG. 4 is a schematic flowchart of a decoding method according to an embodiment of this application.

FIG. 5 is a schematic flowchart of an encoding method according to an embodiment of this application.

FIG. 6 is a detailed schematic flowchart of an encoding method according to an embodiment of this application.

FIG. 7 is a schematic diagram of a scanning sequence of an octree node according to an embodiment of this application.

FIG. 8 is a schematic diagram showing distribution of child neighbor nodes and coplanar parent neighbor nodes of a child node 0 according to an embodiment of this application.

FIG. 9 is a schematic diagram showing a distribution sequence of 20 parent neighbor nodes of a child node 0 according to an embodiment of this application.

FIG. 10A is a schematic diagram showing distribution of child nodes of a current node according to an embodiment of this application.

FIG. 10B is a schematic diagram showing distribution of child nodes of another current node according to an embodiment of this application.

FIG. 11 is a schematic diagram showing distribution of child neighbor nodes and coplanar parent neighbor nodes of a child node 1 according to an embodiment of this application.

FIG. 12 is a schematic diagram showing a distribution sequence of 20 parent neighbor nodes of a child node 1 according to an embodiment of this application.

FIG. 13 is a detailed schematic flowchart of another encoding method according to an embodiment of this application.

FIG. 14 is a schematic diagram of a structure of an encoder according to an embodiment of this application.

FIG. 15 is a schematic diagram of a hardware structure of an encoder according to an embodiment of this application.

FIG. 16 is a schematic diagram of a structure of a decoder according to an embodiment of this application.

FIG. 17 is a schematic diagram of a hardware structure a decoder according to an embodiment of this application.

FIG. 18 is a schematic structural diagram of a coding system according to an embodiment of this application.

### DESCRIPTION OF EMBODIMENTS

To understand features and technical contents of embodiments of this application in more detail, the following describes implementation of embodiments of this application in detail with reference to the accompanying drawings. The accompanying drawings are merely used for description, and are not intended to limit embodiments of this application.

Unless otherwise defined, all technical and scientific terms used in this specification have the same meaning as commonly understood by those skilled in the technical field of this application. The terms used herein are merely for the purpose of describing embodiments of this application, but are not intended to limit this application.

In the following description, the term “some embodiments” describes a subset of all possible embodiments, but it may be understood that “some embodiments” may be the same subset or different subsets of all possible embodiments and may be combined without a conflict. It should also be noted that the term “first/second/third” used in embodiments of this application is merely used to distinguish between similar objects and does not represent a specific order of objects. It may be understood that “first/second/third” may be interchanged if allowed, so that the embodiments of this application described herein may be implemented in a sequence other than the sequence illustrated or described herein.

The names and terms used in embodiments of this application are described before providing a more detailed description of embodiments of this application, and the names and terms used in embodiments of this application are applicable to the following explanations:
point cloud compression (Point Cloud Compression, PCC);
geometry-based point cloud compression (Geometry-based Point Cloud Compression, G-PCC or GPCC);
video-based point cloud compression (Video-based Point Cloud Compression, V-PCC or VPCC);
octree (Octree);
triangle soup (Triangle soup, Trisoup);
intra prediction (Intra Prediction);
look up table (Look Up Table, LUT);
red-green-blue (Red-Green-Blue, RGB);
luminance-chrominance (Luminance-Chrominance, YUV);
level of detail (Level of Detail, LOD);
predicting transform (Predicting Transform);
lifting transform (Lifting Transform);
region adaptive hierarchal transform (Region Adaptive Hierarchal Transform, RAHT); and
context-based adaptive binary arithmetic coding (Context-based Adaptive Binary Arithmetic Coding, CABAC).

It may be understood that a point cloud (Point Cloud) is a three-dimensional representation of a surface of an object. A point cloud (data) on a surface of an object may be collected by using a collection device such as an optoelectronic radar, a laser radar, a laser scanner, and a multi-angle camera.

In addition, the point cloud is a set of massive three-dimensional points, and a point in the point cloud may include location information of the point and attribute information of the point. For example, the location information of the point may be three-dimensional coordinate information of the point, and may also be referred to as geometric information of the point. For example, the attribute information of the point may include colour information, reflectivity, and/or the like. For example, the colour information may be information in any colour space. For example, the colour information may be RGB information, where R denotes red (Red, R), G denotes green (Green, G), and B denotes blue (Blue, B). For another example, the colour information may be information about luminance and chrominance (YCbCr, YUV), where Y denotes luminance, Cb(U) denotes blue chroma, and Cr(V) denotes red chroma.

For a point cloud obtained according to the laser measurement principle, a point in the point cloud may include three-dimensional coordinate information of the point and laser reflectance (reflectance) of the point. For another example, for a point cloud obtained according to the photographing measurement principle, a point in the point cloud may include three-dimensional coordinate information of the point and colour information of the point. For another example, for a point cloud obtained with reference to the laser measurement principle and photographing measurement principle, a point in the point cloud may include three-dimensional coordinate information of the point, laser reflectance (reflectance) of the point, and colour information of the point.

Point clouds may be classified into the following three types according to acquisition methods.

Type 1: Static point cloud, for which an object is still, and a device for acquiring the point cloud is also still.

Type 2: Dynamic point cloud, for which an object is moving, but a device for acquiring the point cloud is still.

Type 3: Dynamically acquired point cloud, for which a device for acquiring the point cloud is moving

For example, point clouds are classified into the following two types according to their usage.

Type 1: Machine perception point cloud, which may be used in a scenario such as an autonomous navigation system, a real-time inspection system, a geographic information system, a visual sorting robot, or a disaster relief robot.

Type 2: Human eye perception point cloud, which may be used in a point cloud application scenario such as a digital cultural heritage, free view broadcasting, three-dimensional immersion communication, or three-dimensional immersion interaction.

Since a point cloud is a collection of massive points, storing the point cloud consumes a large amount of memory, and is also not conducive to transmission. In addition, there is no such bandwidth that may support direct transmission of a point cloud without compression at a network layer. Therefore, it is necessary to compress the point cloud.

As of now, a point cloud encoding framework that can compress a point cloud may be a G-PCC coding framework or a V-PCC coding framework provided by a moving picture experts group (Moving Picture Experts Group, MPEG), or an AVS-PCC coding framework provided by an audio video standard (Audio Video Standard, AVS). The G-PCC coding framework may be configured to compress the static point cloud of type 1 and the dynamically acquired point cloud of type 3, and the V-PCC coding framework may be configured to compress the dynamic point cloud of type 2. The G-PCC coding framework is mainly described in embodiments of this application.

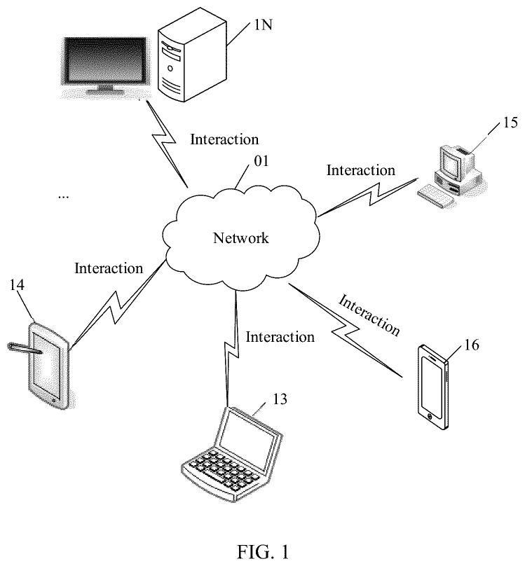

Embodiments of this application provide a network architecture of a point cloud coding system including a decoding method and an encoding method. FIG. 1 is a schematic diagram of a network architecture of point cloud coding according to an embodiment of this application. As shown in FIG. 1, the network architecture includes one or more electronic devices 13 to 1N and a communication network 01. The electronic devices 13 to 1N may perform video interaction with each other through the communication network 01. In an implementation process, the electronic devices may be implemented as various types of devices having a point cloud coding function. For example, the electronic devices may include a smartphone, a tablet computer, a personal computer, a personal digital assistant, a navigator, a digital phone, a videophone, a television, a sensing device, a server, and the like, which is not limitation in embodiments of this application. The decoder or the encoder in embodiments of this application may be the foregoing electronic device.

The electronic devices in embodiments of this application have a point cloud coding function, and generally include a point cloud encoder (namely, an encoder) and a point cloud decoder (namely, a decoder).

The following describes related technologies by using the G-PCC coding framework as an example.

It may be understood that, in a point cloud G-PCC coding framework, point cloud data to be encoded is first partitioned into a plurality of slices through slicing (slice). In each slice, geometric information of each point cloud and attribute information corresponding to the point cloud are separately encoded.

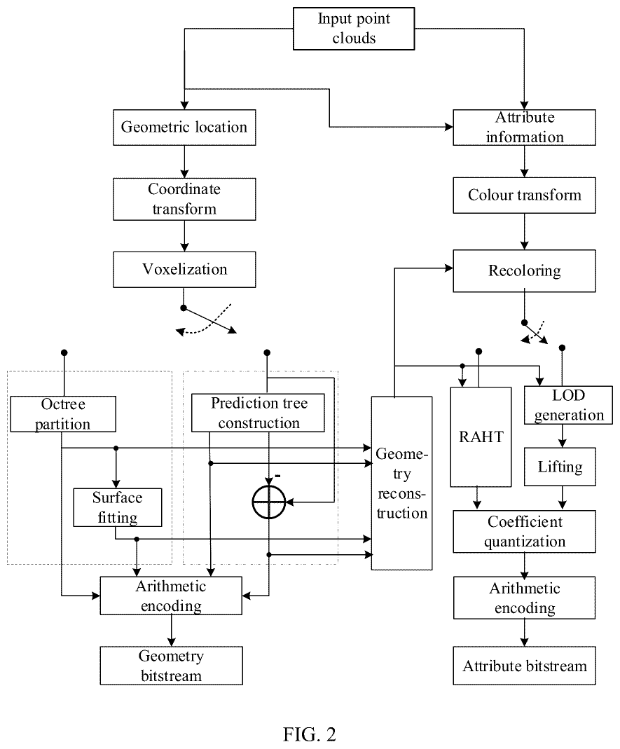

FIG. 2 is a schematic diagram of a framework of a G-PCC encoder. As shown in FIG. 2, in a geometric encoding process, coordinate transform is performed on geometric information, so that the whole point cloud is included in a bounding box (Bounding Box), and then quantization is performed. The quantization in this step mainly plays a role of scaling. Because of rounding operations in the quantization, a part of the point cloud has the same geometric information. Then whether to remove duplicate points is determined based on a parameter. The process of quantization and removal of duplicate points is also referred to as voxelization. Next, octree partition or prediction tree construction is performed on the bounding box. In this process, arithmetic encoding is performed on points in leaf nodes obtained by partition, to generate a binary geometry bitstream; or arithmetic encoding (surface fitting based on vertices) is performed on vertices (Vertex) generated by partition, to generate a binary geometry bitstream. In an attribute encoding process, geometric encoding is already completed. After the geometric information is reconstructed, colour transform is required to be performed first, and colour information (namely, attribute information) is transformed from RGB colour space to YUV colour space. Then, the point cloud is colored again by using the reconstructed geometric information, so that attribute information that is not encoded corresponds to the reconstructed geometric information. The attribute encoding is mainly performed on colour information. In a process of encoding the colour information, there are mainly two transform methods: one is distance-based lifting transformation depending on LOD partition, and the other is RAHT transformation. Both methods make the colour information be transformed from a spatial domain to a frequency domain, obtaining a high-frequency coefficient and a low-frequency coefficient. Finally, the coefficients are quantized to obtain quantized coefficients, and then arithmetic encoding is performed on the quantized coefficients to generate a binary attribute bitstream.

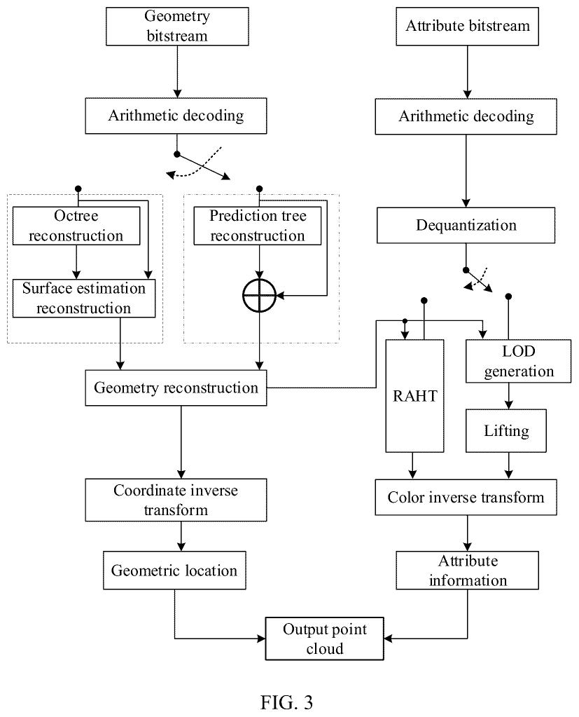

FIG. 3 is a schematic diagram of a framework of a G-PCC decoder. As shown in FIG. 3, for an acquired binary bitstream, a geometric bitstream and an attribute bitstream in the binary bitstream are first separately decoded. During decoding of the geometry bitstream, geometric information of the point cloud is obtained through arithmetic decoding-reconstructing an octree/reconstructing a prediction tree-reconstructing geometry-coordinate inverse transform. During decoding of the attribute bitstream, attribute information of the point cloud is obtained through arithmetic decoding-dequantization-LOD partition/RAHT-colour inverse transform, and point cloud data to be encoded is restored based on the geometric information and the attribute information (that is, the point cloud is outputted).

It should be noted that, as shown in FIG. 2 or FIG. 3, currently G-PCC geometric coding may be octree geometry coding (shown in a dashed box) or predictive geometry coding (shown in a dash-dotted box).

The octree geometry encoding (Octree geometry encoding, OctGeomEnc) includes the following steps. First, coordinate transform is performed on geometric information, so that the whole point cloud is included in a bounding box, and then quantization is performed. The quantization in this step mainly plays a role of scaling. Due to the rounding operations in the quantization, some points may have the same geometric information. Then whether to remove duplicate points is determined based on a parameter. The process of quantization and removal of duplicate points is also referred to as voxelization. Next, tree division (for example, octree, quadtree, and binary tree) is continuously performed on the bounding box in a breadth-first traversal sequence. For a child node generated through partition, one bit (Bit) is used to indicate whether a square block corresponding to the node in space includes a point, which is referred to as an “occupation code”. Encoding is performed on occupation code of each node. In the octree geometry encoding framework, the bounding box is sequentially partitioned to obtain child nodes, and child nodes that are not empty (including a point of a point cloud) continue to be partitioned until a leaf node obtained becomes a unit cube of 1×1×1, and then encoding is performed on points included in the leaf node, to finally complete encoding of the geometry octree, to generate a binary bitstream. In a triangle soup geometric encoding framework, octree partition is also required to be performed first. However, different from octree geometric information encoding, this method does not require hierarchically partitioning the point cloud into a unit cube with a side length of 1×1×1. Instead, partition stops when a side length of a block (Block) is W. Based on a surface formed by distribution of point cloud in each Block, a maximum of twelve vertices (Vertex) are formed by the surface and twelve sides of the block. Vertex coordinates of all Block are sequentially encoded to generate a binary bitstream.

For octree geometry decoding, on a decoding side, parsing is continuously performed in a breadth-first traversal sequence to obtain occupation code of respective nodes, and the respective nodes are sequentially partitioned continuously until a unit cube of 1×1×1 is obtained. Then parsing is performed to obtain a quantity of points included in each leaf node, and finally geometric reconstruction point cloud information is obtained.

Predictive geometry encoding (Predictive geometry coding, PredGeom Tree) includes: sorting an input point cloud in sequence first, where sorting methods currently used include disordering, Morton ordering, azimuth ordering, and radial distance ordering. On an encoding side, a prediction tree structure is established in two different modes: high-latency slow mode (KD-Tree, KD tree) and low-latency fast mode (assigning the points to different lasers (Laser) by using laser calibration information, and building a predictive tree structure based on different lasers). Next, based on the prediction tree structure, each node in the prediction tree is traversed, geometric location information of the node is predicted by selecting different prediction modes to obtain a geometric prediction residual, and the geometric prediction residual is quantized by using a quantization parameter. Finally, encoding is performed on the prediction residual of location information of the prediction tree node, the prediction tree structure, the quantization parameter, and the like by means of continuous iteration, to generate a binary bitstream.

For predictive geometry decoding, a prediction tree structure is reconstructed on the decoding side by continuously parsing bitstreams, then prediction residual information of geometric locations of respective prediction nodes and quantization parameters are obtained through parsing, and dequantization is performed on the prediction residual to obtain reconstructed geometric location information of respective nodes. Finally, geometric reconstruction on the decoding end is completed.

In a related technology, an optimal binarization with update on the fly (Optimal Binarization with Update on the Fly, OBUF) technology is proposed for octree encoding. A dynamic OBUF process includes two phases: (1) context information of occupation code to be encoded is acquired and reduced, and information required to be reduced is dynamically adjusted with an encoding process; and (2) the reduced context information is mapped to a relatively small quantity of binary encoder sets, and each time after encoding of occupation code is completed, the index mapping relationship is also updated.

In the foregoing process, a purpose of updating an index mapping table is to find an encoder having a closer probability for a current context state. In the related art, it is assumed that a probability value maintained by the encoder increases or decreases monotonously with an index value of the encoder. However, in an encoding process, information about some parameters of the encoder is improperly set, for example, probability initial values of the encoder are always 0.5 (which is 32768 if the probability initial value has a 16-bit precision, for example). In addition, both the probability value maintained by the encoder and an index mapping table undergo updates. In this case, the probability value maintained by the encoder is not necessarily increased or decreased monotonically with the index value of the encoder at any instant, making it difficult to select a most matched encoder for encoding in the encoding process, thereby reducing coding efficiency.

An embodiment of this application provides an encoding method, in which candidate data processing modes is determined based on a first preset condition; a data processing mode parameter corresponding to a to-be-encoded syntax element is determined; a target data processing mode is determined based on the candidate data processing modes and the data processing mode parameter; and a value of the to-be-encoded syntax element is encoded based on the target data processing mode, and the encoded value is written into a bitstream.

An embodiment of this application further provides a decoding method, in which candidate data processing modes is determined based on a first preset condition; a data processing mode parameter corresponding to a to-be-decoded syntax element is determined; a target data processing mode is determined based on the candidate data processing modes and the data processing mode parameter; and the to-be-decoded syntax element is decoded based on the target data processing mode, to determine a value of the to-be-decoded syntax element.

Thus, on both the encoding side and the decoding side, candidate data processing modes are determined based on a first preset condition; then a corresponding data processing mode parameter is determined based on a to-be-encoded syntax element or a to-be-decoded syntax element, so that a target data processing mode may be determined; and finally, coding processing is performed on the syntax element based on the target data processing mode. In this way, since the candidate data processing modes meet the first preset condition, in an encoding process, an optimal target encoder can be selected from the candidate data processing modes for encoding, so that a bit rate can be reduced and coding efficiency can be improved, thereby further improving coding performance.

The following describes embodiments of this application in detail with reference to the accompanying drawings.

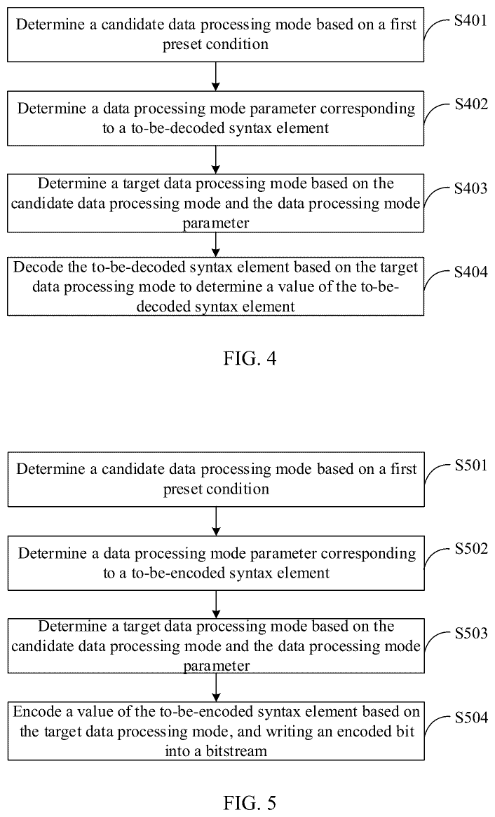

FIG. 4 is a schematic flowchart of a decoding method according to an embodiment of this application. As shown in FIG. 4, the method may include S401 to S404.

S401. Candidate data processing modes is determined based on a first preset condition.

It should be noted that the decoding method in embodiments of this application is applied to a decoder (or referred to as “entropy decoder”). In addition, the decoding method may specifically refer to a point cloud decoding method, or a point cloud entropy decoding method. According to this method, a process of decoding a to-be-decoded syntax element can be implemented, and a bit rate can be reduced.

It should be further noted that, in embodiments of this application, a data processing mode may be used to implement a decoding function. In other words, the data processing mode herein may be considered as a decoding method/an entropy decoding method, or may be considered as a decoder/an entropy decoder.

It should be understood that, in embodiments of this application, there may be a plurality of candidate data processing modes, that is, there are a plurality of candidate decoders.

Subsequently, a target decoder is selected from the plurality of candidate decoders, to decode a to-be-decoded syntax element by using the selected target decoder. In addition, in embodiments of this application, there may be only one candidate data processing mode, that is, there is only one candidate decoder. In this case, different configuration parameters may be set for the candidate decoder, and then a to-be-decoded syntax element is decoded by using a decoder corresponding to a target configuration parameter, which is not limited herein.

It should be further understood that, in embodiments of this application, the first preset condition may be related to an initialization parameter, or the first preset condition may be related to a threshold parameter (for example, an upper limit threshold parameter and/or a lower limit threshold parameter). The candidate data processing modes are determined based on the first preset condition, so that decoding efficiency can be improved in a decoding process.

In some embodiments, the determining the candidate data processing modes based on the first preset condition may include: determining initialization parameters of the candidate data processing modes based on the first preset condition.

It should be noted that, in embodiments of this application, the initialization parameter may indicate a probability value of the candidate data processing mode. In other words, in embodiments of this application, probability initial values of the candidate data processing modes may be set, so as to meet a descending order or an ascending order of probability initial values of the candidate data processing modes.

Further, in some embodiments, the determining the initialization parameters of the candidate data processing modes based on the first preset condition may include: determining a first sorting indication parameter based on the initialization parameters of the candidate data processing modes.

It should be further noted that, in embodiments of this application, values of the first sorting indication parameter may include a first preset value and a second preset value. The first preset value indicates a descending order of initialization parameters, and the second preset value indicates an ascending order of initialization parameters.

For example, it is assumed that there are K candidate data processing modes. When initialization parameters of the K candidate data processing modes are T₀, T₁ . . . Tᵢ . . . T_{K-1} in sequence, for the first preset value, a descending order of the initialization parameters is T₀≥T₁≥ . . . ≥Tᵢ≥ . . . ≥T_{K-1}; and for the second preset value, an ascending order of the initialization parameters is T₀≤T₁≤ . . . ≤Tᵢ≤ . . . ≤T_{K-1}.

In a possible implementation, the method may further include: determining a third preset value and a fourth preset value of the candidate data processing modes; and determining a value of the first sorting indication parameter based on the third preset value and the fourth preset value.

It should be understood that, in embodiments of this application, the third preset value indicates an update order of probability values of the candidate data processing modes, and the fourth preset value indicates an update order of index values of the candidate data processing modes.

In other words, the third preset value may indicate an update direction of probabilities of a candidate decoder, and the fourth preset value may indicate an update direction of an index mapping table of the candidate decoder. In this way, whether the initialization parameters are in a descending order or an ascending order can be determined based on the update direction of the probabilities of the candidate decoder and the update direction of the index mapping table of the candidate decoder.

In a specific embodiment, the determining the value of the first sorting indication parameter based on the third preset value and the fourth preset value may include:
in a case that the third preset value is different from the fourth preset value, determining that the value of the first sorting indication parameter is the first preset value;
in a case that the third preset value is the same as the fourth preset value, determining that the value of the first sorting indication parameter is the second preset value.

It should be further understood that, in embodiments of this application, for the third preset value and the fourth preset value, in a possible implementation, if the third preset value is equal to 1, it indicates that the update direction of the probabilities of the candidate decoder is a descending direction; if the third preset value is equal to 0, it indicates that the update direction of the probabilities of the candidate decoder is an ascending direction; and if the fourth preset value is equal to 1, it indicates that the update direction of the index mapping table of the candidate decoder is a descending direction; if the fourth preset value is equal to 0, it indicates that the update direction of the index mapping table of the candidate decoder is an ascending direction.

In another possible implementation, if the third preset value is equal to 0, it indicates that the update direction of the probabilities of the candidate decoder is a descending direction; if the third preset value is equal to 1, it indicates that the update direction of the probabilities of the candidate decoder is an ascending direction; and if the fourth preset value is equal to 0, it indicates that the update direction of the index mapping table of the candidate decoder is a descending direction; if the fourth preset value is equal to 1, it indicates that the update direction of the index mapping table of the candidate decoder is an ascending direction.

In this way, if the third preset value is different from the fourth preset value, it means that the update direction of the probabilities of the candidate decoder is opposite to the update direction of the index mapping table of the candidate decoder, and in this case, the value of the first sorting indication parameter is the first preset value, that is, the first sorting indication parameter indicates a descending order of the initialization parameters, which is specifically: T₀≥T₁≥ . . . ≥Tᵢ≥ . . . ≥T_{K-1}; if the third preset value is the same as the fourth preset value, it means that the update direction of the probabilities of the candidate decoder is the same as the update direction of the index mapping table of the candidate decoder, and in this case, the value of the first sorting indication parameter is the second preset value, that is, the first sorting indication parameter indicates an ascending order of the initialization parameters, which is specifically: T₀≤T₁≤ . . . ≤Tᵢ≤ . . . ≤T_{K-1}.

It should be further understood that, in embodiments of this application, if both probability values of the candidate decoder and corresponding index values in the index mapping table increase (or remain unchanged) or decrease (or remain unchanged), it may be determined that the update direction of the probabilities of the candidate decoder is the same as the update direction of the index mapping table of the candidate decoder; otherwise, it may be determined that the update direction of the probabilities of the candidate decoder is opposite to the update direction of the index mapping table of the candidate decoder.

In another possible implementation, the method may further include: determining a first parameter corresponding to the candidate data processing modes; and determining the value of the first sorting indication parameter based on the first parameter.

It should be understood that, in embodiments of this application, the first parameter corresponding to the candidate data processing mode may refer to a symbol (Symbol) corresponding to a probability value stored in the candidate decoder. For example, the first parameter may indicate a specific value such as 0 or 1; or the first parameter may indicate a symbol in binary arithmetic encoding, for example, a symbol of 0 or 1, which is not limited herein.

In a specific embodiment, the determining the value of the first sorting indication parameter based on the first parameter may include:
in a case that the first parameter indicates first data, determining that the value of the first sorting indication parameter is the first preset value;
in a case that the first parameter indicates second data, determining that the value of the first sorting indication parameter is the second preset value.

It should be further understood that, in embodiments of this application, the first data may be a symbol “0”, and the second data may be a symbol “1”. For example, if the probability value stored in the candidate decoder is a probability value of the symbol “0” with 16-bit precision, the value of the first sorting indication parameter is the first preset value, that is, the first sorting indication parameter indicates a descending order of the initialization parameters, which is specifically: T₀≥T₁≥. . . ≥Tᵢ≥ . . . ≥T_{K-1}; if the probability value stored in the candidate decoder is a probability value of the symbol “1” with 16-bit precision, the value of the first sorting indication parameter is the second preset value, that is, the first sorting indication parameter indicates an ascending order of the initialization parameters, which is specifically: T₀≤T₁≤ . . . ≤Tᵢ≤ . . . ≤T_{K-1}.

In this way, whether the initialization parameters are in a descending order or an ascending order can be determined not only based on the update direction of the probabilities of the candidate decoder and the update direction of the index mapping table of the candidate decoder, but also based on the symbol (Symbol) corresponding to the probability value stored in the candidate decoder.

In still another possible implementation, the method may further include:
when the value of the first sorting indication parameter is the first preset value, Tᵢ₋₁ is greater than or equal to Tᵢ;
when the value of the first sorting indication parameter is the second preset value, Tᵢ₋₁ is less than or equal to Tᵢ.

Herein Tᵢ is the initialization parameters of the candidate data processing modes, i=1, 2, . . . , K−1, and K represents a quantity of the candidate data processing modes.

For example, when the value of the first sorting indication parameter is the first preset value, T₀≥T₁≥ . . . ≥Tᵢ≥ . . . ≥T_{K-1}; when the value of the first sorting indication parameter is the second preset value, T₀≤T₁≤ . . . ≤Tᵢ≤ . . . ≤T_{K-1}.

In some other embodiments, the determining the candidate data processing modes based on the first preset condition may include: determining threshold parameters of the candidate data processing modes based on the first preset condition.

It should be noted that, in embodiments of this application, the threshold parameter may indicate a probability threshold of a candidate data processing mode, and the probability threshold includes an upper probability limit and/or a lower probability limit. In other words, in embodiments of this application, the probability thresholds of the candidate data processing modes may be set, so as to meet a descending order or an ascending order of probability thresholds of the candidate data processing modes.

Further, in some embodiments, the determining the threshold parameters of the candidate data processing modes based on the first preset condition may include: determining a second sorting indication parameter based on the threshold parameters of the candidate data processing modes.

It should be further noted that, in embodiments of this application, values of the second sorting indication parameter include a fifth preset value and a sixth preset value. The fifth preset value indicates a descending order of threshold parameters, and the sixth preset value indicates an ascending order of the threshold parameters.

For example, it is assumed that there are K candidate data processing modes. When lower limit threshold parameters of the K candidate data processing modes are L₀, L₁ . . . Lᵢ . . . L_{K-1} in sequence, for the fifth preset value, a descending order of the lower limit threshold parameters is L₀≥L₁≥. . . ≥Lᵢ≥ . . . ≥L_{K-1}; and for the sixth preset value, an ascending order of the lower limit threshold parameters is L₀≤L₁≤ . . . ≤Lᵢ≤ . . . ≤L_{K-1}. When upper limit threshold parameters of the K candidate data processing modes are U₀, U₁ . . . Uᵢ . . . U_{K-1} in sequence, for the fifth preset value, a descending order of the upper limit threshold parameters is U₀≥U₁≥ . . . ≥Uᵢ≥ . . . ≥U_{K-1}; and for the sixth preset value, an ascending order of the upper limit threshold parameters is U₀≤U₁≤ . . . ≤Uᵢ≤ . . . ≤U_{K-1}.

In a possible implementation, the method may further include: determining a third preset value and a fourth preset value of the candidate data processing modes; and determining the value of the second sorting indication parameter based on the third preset value and the fourth preset value.

It should be understood that, in embodiments of this application, the third preset value indicates an update order of probability values of the candidate data processing modes, and the fourth preset value indicates an update order of index values of the candidate data processing modes.

In other words, the third preset value may indicate an update direction of probabilities of a candidate decoder, and the fourth preset value may indicate an update direction of an index mapping table of the candidate decoder. In this way, whether the threshold parameters (such as lower limit threshold parameters and upper limit threshold parameters) are in a descending order or an ascending order can be determined based on the update direction of the probabilities of the candidate decoder and the update direction of the index mapping table of the candidate decoder.

In a specific embodiment, the determining the value of the second sorting indication parameter based on the third preset value and the fourth preset value may include:
in a case that the third preset value is different from the fourth preset value, determining that the value of the second sorting indication parameter is the fifth preset value;
in a case that the third preset value is the same as the fourth preset value, determining that the value of the second sorting indication parameter is the sixth preset value.

It should be noted that, in embodiments of this application, for the third preset value and the fourth preset value, reference may be made to the foregoing description. Details are not described herein again.

It should be further noted that, in embodiments of this application, if the third preset value is different from the fourth preset value, it means that the update direction of the probabilities of the candidate decoder is opposite to the update direction of the index mapping table of the candidate decoder, and in this case, the value of the second sorting indication parameter is the fifth preset value, that is, the second sorting indication parameter indicates a descending order of the threshold parameters, which is specifically L₀≥L₁≥ . . . ≥Lᵢ≥ . . . ≥L_{K-1}, and U₀≥U₁≥ . . . ≥Uᵢ≥ . . . ≥U_{K-1}; if the third preset value is the same as the fourth preset value, it means that the update direction of the probabilities of the candidate decoder is the same as the update direction of the index mapping table of the candidate decoder, and in this case, the value of the second sorting indication parameter is the sixth preset value, that is, the second sorting indication parameter indicates an ascending order of the threshold parameters, which is specifically L₀≤L₁≤ . . . ≤Lᵢ≤ . . . ≤L_{K-1}, and U₀≤U₁≤ . . . ≤Uᵢ≤ . . . ≤U_{K-1}.

In another possible implementation, the method may further include: determining a first parameter corresponding to the candidate data processing modes; and determining the value of the second sorting indication parameter based on the first parameter.

In a specific embodiment, the determining the value of the second sorting indication parameter based on the first parameter may include:
in a case that the first parameter indicates first data, determining that the value of the second sorting indication parameter is the fifth preset value;
in a case that the first parameter indicates second data, determining that the value of the second sorting indication parameter is the sixth preset value.

It should be noted that, in embodiments of this application, for description of the first parameter, reference may be made to the foregoing description. Details are not described herein again. For example, the first data may be a symbol “0”, and the second data may be a symbol “1”. For example, if the probability value stored in the candidate decoder is a probability value of the symbol “0” with 16-bit precision, the value of the second sorting indication parameter is the fifth preset value, that is, the fifth sorting indication parameter may indicate a descending order of the lower limit threshold parameters, which is specifically: L₀≥L₁≥ . . . ≥Lᵢ≥ . . . ≥L_{K-1}, and indicates a descending order of the upper limit threshold parameters, which is specifically: U₀≥U₁≥ . . . ≥Uᵢ≥ . . . ≥U_{K-1}; if the probability value stored in the candidate decoder is a probability value of the symbol “1” with 16-bit precision, the value of the second sorting indication parameter is the sixth preset value, that is, the sixth sorting indication parameter may indicate an ascending order of the lower limit threshold parameters, which is specifically: L₀≤L₁≤ . . . ≤Lᵢ≤ . . . ≤L_{K-1}, and indicates an ascending order of the upper limit threshold parameters, which is specifically: U₀≤U₁≤ . . . ≤Uᵢ≤ . . . ≤U_{K-1}.

In this way, whether the threshold parameters are in a descending order or an ascending order can be determined not only based on the update direction of the probabilities of the candidate decoder and the update direction of the index mapping table of the candidate decoder, but also based on the symbol (Symbol) corresponding to the probability value stored in the candidate decoder. In addition, the threshold parameters herein may include a lower limit threshold parameter (such as the lower probability limit) and/or an upper limit threshold parameter (such as the upper probability limit).

In still another possible implementation, the method may further include: when the value of the second sorting indication parameter is the fifth preset value, in a case that the threshold parameter is a lower limit threshold parameter, Lᵢ₋₁ is greater than or equal to Lᵢ; in a case that the threshold parameter is an upper limit threshold parameter, Uᵢ₋₁ is greater than or equal to Uᵢ;
when the value of the second sorting indication parameter is the sixth preset value, in a case that the threshold parameter is a lower limit threshold parameter, Li−1 is less than or equal to Li; in a case that the threshold parameter is an upper limit threshold parameter, Ui−1 is less than or equal to Ui.

In embodiments of this application, Lᵢ is a lower limit threshold parameter of a candidate data processing mode, Uᵢ is an upper limit threshold parameter of a candidate data processing mode, i=1, 2, . . . , K−1, and K represents a quantity of the candidate data processing modes.

For example, when the value of the second sorting indication parameter is the fifth preset value, L₀≥L₁≥ . . . ≥Lᵢ≥ . . . ≥L_{K-1}, and U₀≥U₁≥ . . . ≥Uᵢ≥ . . . ≥U_{K-1}; when the value of the second sorting indication parameter is the sixth preset value, L₀≤L₁≤ . . . ≤Lᵢ≤ . . . ≤L_{K-1}, and U₀≤U₁≤ . . . ≤Uᵢ≤ . . . ≤U_{K-1}.

In still another possible implementation, the method may further include: in the candidate data processing modes, determining that a lower limit threshold parameter of a current candidate data processing mode is the same as an upper limit threshold parameter of an adjacent candidate data processing mode, and determining that an upper limit threshold parameter of the current candidate data processing mode is the same as a lower limit threshold parameter of the adjacent candidate data processing mode.

In a specific embodiment, if the third preset value is different from the fourth preset value, it is determined that Lᵢ₋₁=Uᵢ; if the third preset value is the same as the fourth preset value, it is determined that Uᵢ₋₁=Lᵢ.

In embodiments of this application, the upper limit threshold parameter and the lower limit threshold parameter in the candidate decoder are required to meet that: the lower limit threshold parameter of the current candidate decoder is the same as the upper limit threshold parameter of the adjacent candidate decoder, and the upper limit threshold parameter of the current candidate decoder is the same as the lower limit threshold parameter of the adjacent candidate decoder.

For example, if the update direction of the probabilities of the candidate decoder is opposite to the update direction of the index mapping table of the candidate decoder, Lᵢ₋₁ and Uᵢ are required to meet: Lᵢ₋₁=Uᵢ; if the update direction of the probabilities of the candidate decoder is the same as the update direction of the index mapping table of the candidate decoder, Lᵢ₋₁ and Uᵢ are required to meet: Uᵢ₋₁=Lᵢ.

In still another possible implementation, the method may further include: adjusting threshold parameters of the candidate data processing modes to determine adjusted threshold parameters of the candidate data processing modes.

When the value of the second sorting indication parameter is the fifth preset value, the second sorting indication parameter indicates a descending order of the adjusted threshold parameters; when the value of the second sorting indication parameter is the sixth preset value, the second sorting indication parameter indicates an ascending order of the adjusted threshold parameters.

In embodiments of this application, both the upper limit threshold parameter and the lower limit threshold parameter in the candidate decoder can be dynamically updated and adjusted, as long as an updated upper limit threshold parameter and an updated lower limit threshold parameter can still meet: L₀≥L₁≥ . . . ≥Lᵢ≥ . . . ≥L_{K-1} and U₀≥U₁≥ . . . ≥Uᵢ≥ . . . ≥U_{K-1}; or L₀≤L₁≤ . . . ≤Lᵢ≤ . . . ≤L_{K-1}, and U₀≤U₁≤ . . . ≤Uᵢ≤ . . . ≤U_{K-1}.

S402. A data processing mode parameter corresponding to the to-be-decoded syntax element is determined.

S403. A target data processing mode is determined based on the candidate data processing modes and the data processing mode parameter.

It should be noted that, in embodiments of this application, the to-be-decoded syntax element specifically refers to a syntax element to be decoded on a decoding side. The syntax element herein may be a symbol in binary arithmetic encoding, or may be any syntax element written into a bitstream, which is not limited herein.

It should be further noted that, in embodiments of this application, the data processing mode parameter specifically refers to an index value corresponding to the candidate data processing mode. In some embodiments, the determining the data processing mode parameter corresponding to the to-be-decoded syntax element may include: determining context information of the to-be-decoded syntax element; and determining the data processing mode parameter based on the context information and a preset mapping table.

Further, in some embodiments, the determining the data processing mode parameter based on the context information and the preset mapping table may include: determining a context state of the to-be-decoded syntax element based on the context information; and determining the data processing mode parameter based on the context state and the preset mapping table.

It should be noted that, in embodiments of this application, the preset mapping table may be used to represent a mapping relationship between the context state and the data processing mode parameter.

It should be further noted that, in embodiments of this application, the context information may be classified into primary information and secondary information depending on importance of the information. The primary information cannot be reduced, while the secondary information is possible to be reduced. After a dynamic reducing process, remaining context information forms a context state (denoted by D). Each context state D has a counter N, which is used to record a quantity of times a current state D has been accessed. If N is greater than a preset threshold, the dynamic reducing process is updated, that is, a syntax element to be encoded subsequently requires more secondary information to form a new context state D.

In this way, after the context state D is determined, the data processing mode parameter corresponding to the to-be-decoded syntax element may be determined according to the preset mapping table. The preset mapping table records a mapping relationship between a plurality of groups of context states and data processing mode parameters, and there is also a correspondence between the data processing mode parameters and data processing modes, so that a target data processing mode (namely, a target decoder) corresponding to the to-be-decoded syntax element can be determined.

Further, in some embodiments, the method may further include: updating the preset mapping table based on a value of the to-be-decoded syntax element.

In a specific embodiment, the updating the preset mapping table may include:
in a case that the value of the to-be-decoded syntax element is a seventh preset value, decreasing the data processing mode parameter in the preset mapping table;
in a case that the value of the to-be-decoded syntax element is an eighth preset value, increasing the data processing mode parameter in the preset mapping table.

It should be noted that, in embodiments of this application, the seventh preset value is different from the eighth preset value, and the seventh preset value and the eighth preset value may be in a parameter form, or may be in a digital form. Specifically, the to-be-decoded syntax element may be a parameter written in a profile (profile), or may be a value of a flag (flag), which is not specifically limited herein.

For example, the seventh preset value may be set to 1, and the eighth preset value may be set to 0. Alternatively, the seventh preset value may be set to 0, and the eighth preset value may be set to 1. Alternatively, the seventh preset value may be set to true, and the eighth preset value may be set to false. Alternatively, the seventh preset value may be set to false, and the eighth preset value may be set to true. In embodiments of this application, the seventh preset value is 0, and the eighth preset value is 1, which is not specifically limited.

It should be further noted that, in embodiments of this application, each time when a syntax element is decoded, the data processing mode parameter in the preset mapping table may be further adjusted based on the value of the syntax element. For example, if a value of a syntax element in current decoding is 0, the data processing mode parameter may be decreased (or remain unchanged); if a value of a syntax element in current decoding is 1, the data processing mode parameter may be increased (or remain unchanged), so as to update the preset mapping table.

S404. The to-be-decoded syntax element is decoded based on the target data processing mode to determine the value of the to-be-decoded syntax element.

It should be noted that, in embodiments of this application, after the target data processing mode (namely, the target decoder) is determined, the to-be-decoded syntax element may be decoded based on the target data processing mode, to obtain the value of the to-be-decoded syntax element.

It should be further noted that, in embodiments of this application, after the to-be-decoded syntax element is decoded, a probability value corresponding to the target decoder may be required to be determined and updated. Therefore, in some embodiments, the method may further include: determining a first probability value of the target data processing mode based on the value of the to-be-decoded syntax element; and updating the first probability value of the target data processing mode to determine a second probability value of the target data processing mode.

In some embodiments, the updating the first probability value of the target data processing mode to determine the second probability value of the target data processing mode may include: determining a second parameter corresponding to the target data processing mode; and updating the first probability value of the target data processing mode based on the second parameter and the value of the to-be-decoded syntax element, to determine the second probability value of target data processing mode.

It should be understood that, in embodiments of this application, the second parameter corresponding to the target data processing mode may refer to a symbol (Symbol) corresponding to a probability value stored in the target decoder. For example, the second parameter may indicate a specific value such as 0 or 1; or the second parameter may indicate a symbol in binary arithmetic encoding, for example, a symbol of 0 or 1, which is not limited herein.

It should be further understood that, in embodiments of this application, after the to-be-decoded syntax element is decoded, if the probability value of the target decoder is used to represent a probability of the second parameter, the probability value of the target decoder may be increased or decreased depending on data indicated in the second parameter.

In a possible implementation, the updating the first probability value of the target data processing mode based on the second parameter and the value of the to-be-decoded syntax element may include:

in a case that the second parameter indicates first data, and the value of the to-be-decoded syntax element is a seventh preset value, increasing the first probability value of the target data processing mode;
in a case that the second parameter indicates first data, and the value of the to-be-decoded syntax element is an eighth preset value, decreasing the first probability value of the target data processing mode.

Alternatively, in another possible implementation, the updating the first probability value of the target data processing mode based on the second parameter and the value of the to-be-decoded syntax element may include:
in a case that the second parameter indicates second data, and a symbol of the to-be-decoded syntax element is a seventh preset value, decreasing the first probability value of the target data processing mode;
in a case that the second parameter indicates second data, and a symbol of the to-be-decoded syntax element is an eighth preset value, increasing the first probability value of the target data processing mode.

For example, if the probability value of the target decoder is used to represent a probability of the symbol “0”, when a syntax element in current decoding is 0, the probability value of the target decoder is increased (or remains unchanged); when a syntax element in current decoding is 1, the probability value of the target decoder is decreased (or remains unchanged). If the probability value of an encoder is used to represent a probability of the symbol “1”, when a syntax element in current decoding is 0, the probability value of the target decoder is decreased (or remains unchanged); when a syntax element in current decoding is 0, the probability value of the target decoder is increased (or remains unchanged).

Further, in some embodiments, the method may further include: modifying the second probability value of the target data processing mode to determine a target probability value of the target data processing mode.

In a specific embodiment, the modifying the second probability value of the target data processing mode to determine the target probability value of the target data processing mode may include:
in a case that the second probability value is less than the lower probability limit, setting the target probability value to the lower probability limit;
in a case that the second probability value is greater than the upper probability limit, setting the target probability value to the upper probability limit;
in a case that the second probability value is greater than or equal to the lower probability limit and less than or equal to the upper probability limit, setting the target probability value to the second probability value.

It should be noted that, in embodiments of this application, the second probability value of the target data processing mode may be denoted by Pᵢ. Thus, for Pᵢ, two thresholds may be set: an upper probability limit (a upper threshold) Uᵢ and a lower probability limit (a lower threshold) Lᵢ, and the two should meet Lᵢ≤Uᵢ. After probability update is executed, Pₖ=Clip3(Lᵢ, Uᵢ, Pᵢ) is further required to be executed, where Clip3(x, y, z) is a truncated calculation function, and a calculation formula is as follows:

$$Clip 3 ( x , y , z ) = \{ \begin{matrix}x ; & z < x \\ y ; & z > y \\ z ; & otherwise\end{matrix} \qquad ( 1 )$$

Herein i=0, 1, 2, . . . , K−1, and K represents a quantity of the candidate data processing modes.

Briefly, in embodiments of this application, a group of candidate decoders with ascending (in ascending order) or descending (in descending order) initialization parameters is proposed herein, and whether ascending (in ascending order) or descending (in descending order) may be determined depending on a symbol corresponding to probability values of the decoders. In addition, the group of candidate decoders still have upper limit threshold parameters and lower limit threshold parameters.

An embodiment provides a decoding method. First, candidate data processing modes are determined based on a first preset condition, and then a corresponding data processing mode parameter is determined based on a to-be-decoded syntax element. Then, a target data processing mode may be determined from the candidate data processing modes, and finally the syntax element is decoded based on the target data processing mode. In this way, since the candidate data processing modes meet the first preset condition of an initialization parameter, an upper limit threshold parameter, a lower limit threshold parameter or the like, in a decoding process, an optimal target decoder can be selected from the candidate data processing modes for decoding, so that a bit rate can be reduced, and coding efficiency and coding performance can be improved.

FIG. 5 is a schematic flowchart of an encoding method according to another embodiment of this application. As shown in FIG. 5, the method may include S501 to S504.

S501. Candidate data processing modes is determined based on a first preset condition.

It should be noted that the encoding method in embodiments of this application is applied to an encoder (or referred to as “entropy encoder”). In addition, the encoding method may specifically refer to a point cloud encoding method, or a point cloud entropy encoding method. According to this method, a process of decoding a to-be-encoded syntax element can be implemented, and a bit rate can be reduced.

It should be further noted that, in embodiments of this application, a data processing mode may be used to implement an encoding function. In other words, the data processing mode herein may be considered as an encoding method/an entropy encoding method, or may be considered as an encoder/an entropy encoder.

It should be understood that, in embodiments of this application, there may be a plurality of candidate data processing modes, that is, there are a plurality of candidate encoders. Subsequently, a target encoder is selected from the plurality of candidate encoders, to encode a value of a to-be-encoded syntax element by using the selected target encoder. In addition, in embodiments of this application, there may be only one candidate data processing mode, that is, there is only one candidate encoder. In this case, different configuration parameters of the candidate encoder may be set, and then the value of the to-be-encoded syntax element is encoded by using an encoder corresponding to a target configuration parameter, which is not limited herein.

It should be further understood that, in embodiments of this application, the first preset condition may be related to an initialization parameter, or the first preset condition may be related to a threshold parameter (for example, an upper limit threshold parameter and/or a lower limit threshold parameter). The candidate data processing modes are determined based on the first preset condition, so that encoding efficiency can be improved in an encoding process.

In some embodiments, the determining the candidate data processing modes based on the first preset condition may include: determining initialization parameters of the candidate data processing modes based on the first preset condition.

It should be noted that, in embodiments of this application, the initialization parameter may indicate a probability value of the candidate data processing mode. In other words, in embodiments of this application, probability initial values of the candidate data processing modes may be set, so as to meet a descending order or an ascending order of the probability initial values of the candidate data processing modes.

Further, in some embodiments, the determining the initialization parameters of the candidate data processing modes based on the first preset condition may include: determining a first sorting indication parameter based on the initialization parameters of the candidate data processing modes.

It should be further noted that, in embodiments of this application, values of the first sorting indication parameter may include a first preset value and a second preset value. The first preset value indicates a descending order of initialization parameters, and the second preset value indicates an ascending order of initialization parameters.

In a possible implementation, the method may further include: determining a third preset value and a fourth preset value of the candidate data processing modes; and determining the value of first sorting indication parameter based on the third preset value and the fourth preset value.

It should be understood that, in embodiments of this application, the third preset value indicates an update order of probability values of candidate data processing modes, and the fourth preset value indicates an update order of index values of the candidate data processing modes.

In other words, the third preset value may indicate an update direction of probabilities of a candidate encoder, and the fourth preset value may indicate an update direction of an index mapping table of the candidate encoder. In this way, whether the initialization parameters are in a descending order or an ascending order can be determined based on the update direction of the probabilities of the candidate encoder and the update direction of the index mapping table of the candidate encoder.

In a specific embodiment, the determining the value of the first sorting indication parameter based on the third preset value and the fourth preset value may include:
in a case that the third preset value is different from the fourth preset value, determining that the value of the first sorting indication parameter is the first preset value;
in a case that the third preset value is the same as the fourth preset value, determining that the value of the first sorting indication parameter is the second preset value.

It should be noted that, in embodiments of this application, for the third preset value and the fourth preset value, reference may be made to the foregoing description. Details are not described herein again.

It should be further noted that, in embodiments of this application, if the third preset value is different from the fourth preset value, it means that the update direction of the probabilities of the candidate encoder is opposite to the update direction of the index mapping table of the candidate encoder, and in this case, the value of the first sorting indication parameter is the first preset value, that is, the first sorting indication parameter indicates a descending order of the initialization parameters, which is specifically T₀≥T₁≥ . . . ≥Tᵢ≥ . . . ≥T_{K-1}; if the third preset value is the same as the fourth preset value, it means that the update direction of the probabilities of the candidate encoder is the same as the update direction of the index mapping table of the candidate encoder, and in this case, the value of the first sorting indication parameter is the second preset value, that is, the first sorting indication parameter indicates an ascending order of the initialization parameters, which is specifically: T₀≤T₁≤ . . . ≤Tᵢ≤ . . . ≤T_{K-1}.

It should be further understood that, in embodiments of this application, if both probability values of the candidate encoder and corresponding index values in the index mapping table increase (or remain unchanged) or decrease (or remain unchanged), it may be determined that the update direction of the probabilities of the candidate encoder is the same as the update direction of the index mapping table of the candidate encoder; otherwise, it may be determined that the update direction of the probabilities of the candidate encoder is opposite to the update direction of the index mapping table of the candidate encoder.

In another possible implementation, the method may further include: determining a first parameter corresponding to the candidate data processing modes; and determining the value of the first sorting indication parameter based on the first parameter.

In a specific embodiment, the determining the value of the first sorting indication parameter based on the first parameter may include:
in a case that the first parameter indicates first data, determining that the value of the first sorting indication parameter is the first preset value;
in a case that the first parameter indicates second data, determining that the value of the first sorting indication parameter is the second preset value.

It should be further understood that, in embodiments of this application, the first data may be a symbol “0”, and the second data may be a symbol “1”. For example, if the probability value stored in the candidate encoder is a probability value of the symbol “0” with 16-bit precision, the value of the first sorting indication parameter is the first preset value, that is, the first sorting indication parameter indicates a descending order of the initialization parameters, which is specifically: T₀≥T₁≥ . . . ≥ Tᵢ≥ . . . ≥T_{K-1}; if the probability value stored in the candidate encoder is a probability value of the symbol “1” with 16-bit precision, the value of the first sorting indication parameter is the second preset value, that is, the first sorting indication parameter indicates an ascending order of the initialization parameters, which is specifically: T₀≤T₁≤ . . . ≤Tᵢ≤ . . . ≤T_{K-1}.

In this way, whether the initialization parameters are in a descending order or an ascending order can be determined not only based on the update direction of the probabilities of the candidate encoder and the update direction of the index mapping table of the candidate decoder, but also based on the symbol (Symbol) corresponding to the probability value stored in the candidate encoder.

In still another possible implementation, the method may further include:
when the value of the first sorting indication parameter is the first preset value, Tᵢ₋₁ is greater than or equal to Tᵢ;
when the value of the first sorting indication parameter is the second preset value, Tᵢ₋₁ is less than or equal to Tᵢ.

Herein Tᵢ is the initialization parameters of the candidate data processing modes, i=1, 2, . . . , K−1, and K represents a quantity of the candidate data processing modes. For example, when the value of the first sorting indication parameter is the first preset value, T₀≥T₁≥ . . . ≥Tᵢ≥ . . . ≥T_{K-1}; when the value of the first sorting indication parameter is the second preset value, T₀≤T₁≤ . . . ≤Tᵢ≤ . . . ≤T_{K-1}.

In some other embodiments, the determining the candidate data processing modes based on the first preset condition may include: determining threshold parameters of the candidate data processing modes based on the first preset condition.

It should be noted that, in embodiments of this application, the threshold parameter may indicate a probability threshold of a candidate data processing mode, and the probability threshold includes an upper probability limit and/or a lower probability limit. In other words, in embodiments of this application, the probability thresholds of the candidate data processing modes may be set, so as to meet a descending order or an ascending order of the probability thresholds of the candidate data processing modes.

Further, in some embodiments, the determining the threshold parameters of the candidate data processing modes based on the first preset condition may include: determining a second sorting indication parameter based on the threshold parameters of the candidate data processing modes.

It should be further noted that, in embodiments of this application, values of the second sorting indication parameter include a fifth preset value and a sixth preset value. The fifth preset value indicates a descending order of threshold parameters, and the sixth preset value indicates an ascending order of the threshold parameters.

In a possible implementation, the method may further include: determining a third preset value and a fourth preset value of the candidate data processing modes; and determining the value of the second sorting indication parameter based on the third preset value and the fourth preset value.

It should be understood that, in embodiments of this application, the third preset value indicates an update order of probability values of the candidate data processing modes, and the fourth preset value indicates an update order of index values of the candidate data processing modes.

In other words, the third preset value may indicate an update direction of probabilities of a candidate encoder, and the fourth preset value may indicate an update direction of an index mapping table of the candidate encoder. In this way, whether the threshold parameters (such as lower limit threshold parameters and upper limit threshold parameters) are in a descending order or an ascending order can be determined based on the update direction of the probabilities of the candidate encoder and the update direction of the index mapping table of the candidate encoder.

In a specific embodiment, the determining the value of the second sorting indication parameter based on the third preset value and the fourth preset value may include:
in a case that the third preset value is different from the fourth preset value, determining that the value of the second sorting indication parameter is the fifth preset value;
in a case that the third preset value is the same as the fourth preset value, determining that the value of the second sorting indication parameter is the sixth preset value.

It should be noted that, in embodiments of this application, for the third preset value and the fourth preset value, reference may be made to the foregoing description. Details are not described herein again.

It should be further noted that, in embodiments of this application, if the third preset value is different from the fourth preset value, it means that the update direction of the probabilities of the candidate encoder is opposite to the update direction of the index mapping table of the candidate encoder, and in this case, the value of the second sorting indication parameter is the fifth preset value, that is, the second sorting indication parameter indicates a descending order of the threshold parameters, which is specifically L₀≥L₁≥ . . . ≥Lᵢ≥ . . . ≥L_{K-1}, and U₀≥U₁≥ . . . ≥Uᵢ≥ . . . ≥U_{K-1}; if the third preset value is the same as the fourth preset value, it means that the update direction of the probabilities of the candidate encoder is the same as the update direction of the index mapping table of the candidate encoder, and in this case, the value of the second sorting indication parameter is the sixth preset value, that is, the second sorting indication parameter indicates an ascending order of the threshold parameters, which is specifically L₀≤L₁≤ . . . ≤Lᵢ≤ . . . ≤L_{K-1}, and U₀≤U₁≤ . . . ≤Uᵢ≤ . . . ≤U_{K-1}.

In another possible implementation, the method may further include: determining a first parameter corresponding to the candidate data processing modes; and determining the value of the second sorting indication parameter based on the first parameter.

In a specific embodiment, the determining the value of the second sorting indication parameter based on the first parameter may include:
in a case that the first parameter indicates first data, determining that the value of the second sorting indication parameter is the fifth preset value;
in a case that the first parameter indicates second data, determining that the value of the second sorting indication parameter is the sixth preset value.

It should be noted that, in embodiments of this application, for description of the first parameter, reference may be made to the foregoing description. Details are not described herein again. For example, the first data may be a symbol “0”, and the second data may be a symbol “1”. For example, if the probability value stored in the candidate encoder is a probability value of the symbol “0” with 16-bit precision, the value of the second sorting indication parameter is the fifth preset value, that is, the fifth sorting indication parameter may indicate a descending order of the lower limit threshold parameters, which is specifically: L₀≥L₁≥ . . . ≥Lᵢ≥ . . . ≥L_{K-1}, and indicates a descending order of the upper limit threshold parameters, which is specifically: U₀≥U₁≥ . . . ≥Uᵢ≥ . . . ≥U_{K-1}; if the probability value stored in the candidate encoder is a probability value of the symbol “1” with 16-bit precision, the value of the second sorting indication parameter is the sixth preset value, that is, the sixth sorting indication parameter may indicate an ascending order of the lower limit threshold parameters, which is specifically: L₀≤L₁≤ . . . ≤Lᵢ≤ . . . ≤L_{K-1}, and indicates an ascending order of the upper limit threshold parameters, which is specifically: U₀≤U₁≤ . . . ≤Uᵢ≤ . . . ≤U_{K-1}.

In this way, whether the threshold parameters are in a descending order or an ascending order can be determined not only based on the update direction of the probabilities of the candidate encoder and the update direction of the index mapping table of the candidate decoder, but also based on the symbol (Symbol) corresponding to the probability value stored in the candidate encoder. In addition, the threshold parameters herein may include a lower limit threshold parameter (such as the lower probability limit) and/or an upper limit threshold parameter (such as the upper probability limit).

In still another possible implementation, the method may further include: when the value of the second sorting indication parameter is the fifth preset value, in a case that the threshold parameter is a lower limit threshold parameter, Lᵢ₋₁ is greater than or equal to Lᵢ; in a case that the threshold parameter is an upper limit threshold parameter, Uᵢ₋₁ is greater than or equal to Uᵢ;

when the value of the second sorting indication parameter is the sixth preset value, in a case that the threshold parameter is a lower limit threshold parameter, Lᵢ₋₁ is less than or equal to Lᵢ; in a case that the threshold parameter is an upper limit threshold parameter, Uᵢ₋₁ is less than or equal to Uᵢ.

In embodiments of this application, Lᵢ is a lower limit threshold parameter of a candidate data processing mode, Uᵢ is an upper limit threshold parameter of a candidate data processing mode, i=1, 2, . . . , K−1, and K represents a quantity of the candidate data processing modes.

For example, when the value of the second sorting indication parameter is the fifth preset value, L₀≥L₁≥ . . . ≥Lᵢ≥ . . . ≥L_{K-1}, and U₀≥U₁≥ . . . ≥Uᵢ≥ . . . ≥U_{K-1}; when the value of the second sorting indication parameter is the sixth preset value, L₀≤L₁≤ . . . ≤Lᵢ≤ . . . ≤L_{K-1}, and U₀≤U₁≤ . . . ≤Uᵢ≤ . . . ≤U_{K-1}.

In still another possible implementation, the method may further include: in the candidate data processing modes, determining that a lower limit threshold parameter of a current candidate data processing mode is the same as an upper limit threshold parameter of an adjacent candidate data processing mode, and determining that an upper limit threshold parameter of the current candidate data processing mode is the same as a lower limit threshold parameter of the adjacent candidate data processing mode.

In a specific embodiment, if the third preset value is different from the fourth preset value, it is determined that Lᵢ₋₁=Uᵢ; if the third preset value is the same as the fourth preset value, it is determined that Uᵢ₋₁=Lᵢ.

In embodiments of this application, the upper limit threshold parameter and the lower limit threshold parameter in the candidate encoder are required to meet that: the lower limit threshold parameter of the current candidate encoder is the same as the upper limit threshold parameter of the adjacent candidate encoder, and the upper limit threshold parameter of the current candidate encoder is the same as the lower limit threshold parameter of the adjacent candidate encoder.

For example, if the update direction of the probabilities of the candidate encoder is opposite to the update direction of the index mapping table of the candidate encoder, Lᵢ₋₁ and Uᵢ are required to meet: Lᵢ₋₁=Uᵢ; if the update direction of the probabilities of the candidate encoder is the same as the update direction of the index mapping table of the candidate encoder, Lᵢ₋₁ and Uᵢ are required to meet: Uᵢ₋₁=Lᵢ.

In still another possible implementation, the method may further include: adjusting threshold parameters of the candidate data processing modes to determine adjusted threshold parameters of the candidate data processing modes.

When the value of the second sorting indication parameter is the fifth preset value, the second sorting indication parameter indicates a descending order of the adjusted threshold parameters; when the value of the second sorting indication parameter is the sixth preset value, the second sorting indication parameter indicates an ascending order of the adjusted threshold parameters.

In embodiments of this application, both the upper limit threshold parameter and the lower limit threshold parameter in the candidate encoder can be dynamically updated and adjusted, as long as an updated upper limit threshold parameter and an updated lower limit threshold parameter can still meet: L₀≥L₁≥ . . . ≥Lᵢ≥ . . . ≥L_{K-1} and U₀≥U₁≥ . . . ≥Uᵢ≥ . . . ≥U_{K-1}; or L₀≤L₁≤ . . . ≤Lᵢ≤ . . . ≤L_{K-1}, and U₀≤U₁≤ . . . ≤Uᵢ≤ . . . ≤U_{K-1}.

S502. A data processing mode parameter corresponding to a to-be-encoded syntax element is determined.

S503. A target data processing mode is determined based on the candidate data processing modes and the data processing mode parameter.

It should be noted that, in embodiments of this application, the to-be-encoded syntax element specifically refers to a syntax element to be encoded on an encoding side. The syntax element herein may be a symbol in binary arithmetic encoding, or may be any syntax element written into a bitstream, which is not limited herein.

It should be further noted that, in embodiments of this application, the data processing mode parameter specifically refers to an index value corresponding to the candidate data processing mode. In some embodiments, the determining the data processing mode parameter corresponding to the to-be-encoded syntax element may include: determining context information of the to-be-encoded syntax element; and determining the data processing mode parameter based on the context information and a preset mapping table.

Further, in some embodiments, the determining the data processing mode parameter based on the context information and the preset mapping table may include: determining a context state of the to-be-encoded syntax element based on the context information; and determining the data processing mode parameter based on the context state and the preset mapping table.

It should be noted that, in embodiments of this application, the preset mapping table may be used to represent a mapping relationship between the context state and the data processing mode parameter.

It should be further noted that, in embodiments of this application, the context information may be classified into primary information and secondary information depending on importance of the information. The primary information cannot be reduced, while the secondary information is possible to be reduced. After a dynamic reducing process, remaining context information forms a context state (denoted by D). Each context state D has a counter N, which is used to record a quantity of times a current state D has been accessed. If N is greater than a preset threshold, the dynamic reducing process is updated, that is, a syntax element to be encoded subsequently requires more secondary information to form a new context state D.

In this way, after the context state D is determined, the data processing mode parameter corresponding to the to-be-encoded syntax element may be determined according to the preset mapping table. The preset mapping table records a mapping relationship between a plurality of groups of context states and data processing mode parameters, and there is also a correspondence between the data processing mode parameters and data processing modes, so that a target data processing mode (namely, a target encoder) corresponding to the to-be-encoded syntax element can be determined.

Further, in some embodiments, the method may further include: updating the preset mapping table based on a value of the to-be-encoded syntax element.

In a specific embodiment, the updating the preset mapping table may include:
in a case that the value of the to-be-encoded syntax element is a seventh preset value, decreasing the data processing mode parameter in the preset mapping table;
in a case that the value of the to-be-encoded syntax element is an eighth preset value, increasing the data processing mode parameter in the preset mapping table.

It should be noted that, in embodiments of this application, the seventh preset value is different from the eighth preset value, and the seventh preset value and the eighth preset value may be in a parameter form, or may be in a digital form. Specifically, the to-be-encoded syntax element may be a parameter written in a profile (profile), or may be a value of a flag (flag), which is not specifically limited herein.

For example, the seventh preset value may be set to 1, and the eighth preset value may be set to 0. Alternatively, the seventh preset value may be set to 0, and the eighth preset value may be set to 1. Alternatively, the seventh preset value may be set to true, and the eighth preset value may be set to false. Alternatively, the seventh preset value may be set to false, and the eighth preset value may be set to true. In embodiments of this application, the seventh preset value is 0, and the eighth preset value is 1, which is not specifically limited.

It should be further noted that, in embodiments of this application, each time when a syntax element is encoded, the data processing mode parameter in the preset mapping table may be further adjusted based on the value of the syntax element. For example, if a value of a syntax element in current encoding is 0, the data processing mode parameter may be decreased (or remain unchanged); if a value of a syntax element in current encoding is 1, the data processing mode parameter may be increased (or remain unchanged), so as to update the preset mapping table.

S504. A value of the to-be-encoded syntax element is encoded based on the target data processing mode, and the encoded value is written into a bitstream.

It should be noted that, in embodiments of this application, after the target data processing mode (namely, the target encoder) is determined, the value of the to-be-encoded syntax element may be encoded based on the target data processing mode, and the encoded value is written into a bitstream.

It should be further noted that, in embodiments of this application, after the to-be-encoded syntax element is encoded, a probability value corresponding to the target encoder may be required to be determined and updated. Therefore, in some embodiments, the method may further include: determining a first probability value of the target data processing mode based on the value of the to-be-encoded syntax element; and updating the first probability value of the target data processing mode to determine a second probability value of the target data processing mode.

In some embodiments, the updating the first probability value of the target data processing mode to determine the second probability value of the target data processing mode may include: determining a second parameter corresponding to the target data processing mode; and updating the first probability value of the target data processing mode based on the second parameter and the value of the to-be-encoded syntax element, to determine the second probability value of the target data processing mode.

It should be understood that, in embodiments of this application, the second parameter corresponding to the target data processing mode may refer to a symbol (Symbol) corresponding to a probability value stored in the target encoder. For example, the second parameter may indicate a specific value such as 0 or 1; or the second parameter may indicate a symbol in binary arithmetic encoding, for example, a symbol of 0 or 1, which is not limited herein.

It should be further understood that, in embodiments of this application, after the to-be-encoded syntax element is encoded, if the probability value of the target encoder is used to represent a probability of the second parameter, the probability value of the target encoder may be increased or decreased depending on data indicated in the second parameter.

In a possible implementation, the updating the first probability value of the target data processing mode based on the second parameter and the value of the to-be-encoded syntax element may include:
in a case that the second parameter indicates first data, and the value of the to-be-encoded syntax element is a seventh preset value, increasing the first probability value of the target data processing mode;
in a case that the second parameter indicates first data, and the value of the to-be-encoded syntax element is an eighth preset value, decreasing the first probability value of the target data processing mode.

Alternatively, in another possible implementation, the updating the first probability value of the target data processing mode based on the second parameter and the value of the to-be-encoded syntax element may include:
in a case that the second parameter indicates second data, and the symbol of the to-be-encoded syntax element is a seventh preset value, decreasing the first probability value of the target data processing mode;
in a case that the second parameter indicates second data, and the symbol of the to-be-encoded syntax element is an eighth preset value, increasing the first probability value of the target data processing mode.

For example, if the probability value of the target encoder represents a probability of the symbol “0”, when a syntax element in current encoding is 0, the probability value of the target encoder is increased (or remains unchanged); when a syntax element in current encoding is 1, the probability value of the target encoder is decreased (or remains unchanged). If the probability value of an encoder represents a probability of the symbol “1”, when a syntax element in current encoding is 0, the probability value of the target encoder is decreased (or remains unchanged); when a syntax element in current encoding is 0, the probability value of the target encoder is increased (or remains unchanged).

Further, in some embodiments, the method may further include: modifying the second probability value of the target data processing mode to determine a target probability value of the target data processing mode.

In a specific embodiment, the modifying the second probability value of the target data processing mode to determine the target probability value of the target data processing mode may include:
in a case that the second probability value is less than the lower probability limit, setting the target probability value to the lower probability limit;
in a case that the second probability value is greater than the upper probability limit, setting the target probability value to the upper probability limit;
in a case that the second probability value is greater than or equal to the lower probability limit and less than or equal to the upper probability limit, setting the target probability value to the second probability value.

It should be noted that, in embodiments of this application, the second probability value of the target data processing mode may be denoted by Pᵢ. Thus, for Pᵢ, two thresholds may be set: an upper probability limit (a upper threshold) Uᵢ and a lower probability limit (a lower threshold) Lᵢ, and the two should meet Lᵢ≤Uᵢ. After probability update is executed, Pₖ=Clip3(Lᵢ, Uᵢ, Pᵢ) is further required to be executed, where Clip3(x, y, z) is a truncated calculation function, and a calculation formula thereof is shown by the formula (1) described above.

Briefly, in embodiments of this application, a group of candidate encoders with ascending (in ascending order) or descending (in descending order) initialization parameters is proposed herein, and whether ascending (in ascending order) or descending (in descending order) may be determined depending on a symbol corresponding to probability values of the encoders. In addition, the group of candidate encoders still have upper limit threshold parameters and lower limit threshold parameters.

Further, an embodiment of this application further provides a bitstream, where the bitstream is generated by performing bit encoding on to-be-encoded information; and the to-be-encoded information at least includes a value of a to-be-encoded syntax element.

It should be further noted that, in embodiments of this application, the to-be-encoded syntax element may be encoded on an encoding side and written into the bitstream. Subsequently, the value of the syntax element may be determined by decoding on a decoding side, so that a related decoding operation is executed on the decoding side by using the value of the syntax element.

An embodiment provides an encoding method. First, candidate data processing modes are determined based on a first preset condition, and then a corresponding data processing mode parameter is determined based on a to-be-encoded syntax element. Then, a target data processing mode may be determined from the candidate data processing modes, and finally the syntax element is encoded based on the target data processing mode. In this way, since the candidate data processing modes meet the first preset condition of an initialization parameter, an upper limit threshold parameter, a lower limit threshold parameter or the like, in an encoding process, an optimal target encoder can be selected from the candidate data processing modes for encoding, so that a bit rate can be reduced and coding efficiency can be improved, thereby further improving coding performance.

In still another embodiment of this application, based on the encoding method and the decoding method in foregoing embodiment, technical solutions in embodiments of this application may be applied to a dynamic OBUF process. The dynamic OBUF process may be applicable to a decoding side, or may be applicable to an encoding side, or may be applicable to both the encoding side and the decoding side, which is not specifically limited herein.

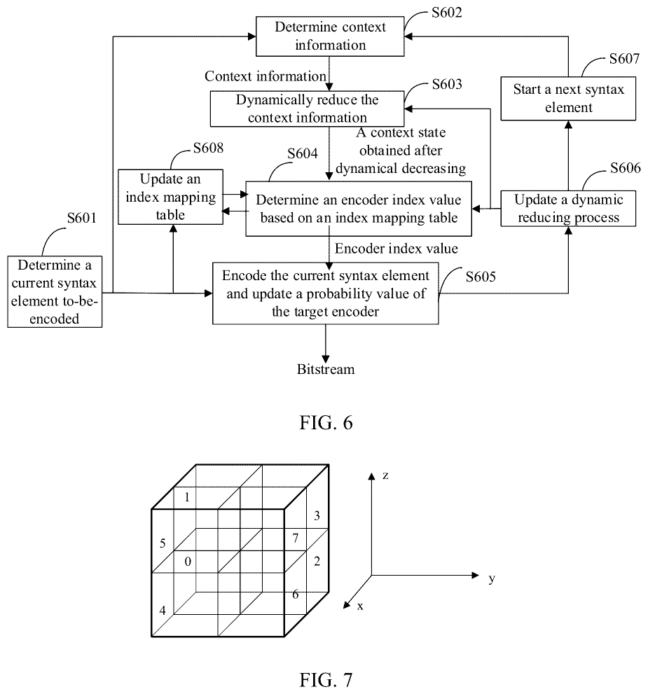

The encoding side is used as an example. FIG. 6 is a detailed schematic flowchart of an encoding method according to an embodiment of this application. As shown in FIG. 6, the detailed procedure may include the following steps.

S601. A to-be-encoded current syntax element is determined.

S602. Context information is determined.

S603. The context information is dynamically reduced to determine a dynamically reduced context state.

S604. An encoder index value is determined based on an index mapping table.

S605. After a target encoder is determined based on the encoder index value, the current syntax element is encoded by using the target encoder and a probability value of the target encoder is updated.

It should be noted that, in embodiments of this application, after the probability value of the target encoder is updated, the following update process may be further performed.

S606. A dynamic reducing process is updated.

S607. A process for a next syntax element starts.

Herein, the context information is an input to OBUF, and is formed by a syntax element that has already been encoded. The context information may be classified into primary information and secondary information depending on importance of the information, where some information in the secondary information is reduced in the dynamic reducing process. In addition, the primary information cannot be reduced, while the secondary information is possible to be reduced. After a dynamic reducing process, the remaining context information forms a context state. Each context state has a counter N, which is used to record a quantity of times a current state has been accessed. If N is greater than a preset threshold, the dynamic reducing process is updated, that is, a syntax element to be encoded subsequently requires more secondary information to form a new context state, which means that the reduced secondary information is dynamically adjusted.

It should be further noted that, in embodiments of this application, for an index mapping table of an encoder, the following update process may be performed.

S608. An index mapping table is updated.

Herein the index mapping table is the preset mapping table in foregoing embodiments. On the encoding side, the index mapping table may specifically refer to the index mapping table of the encoder, and provides a mapping relationship between a context state and an encoder index value. Based on the mapping table, an index value of an encoder that should be used by a to-be-encoded syntax element in any context state may be obtained. Each time when a syntax element is encoded, the mapping relationship between a context state in the mapping table and an encoder index value is adjusted based on a result of the syntax element.

In a specific embodiment, the procedure illustrated in FIG. 6 is described below.

### (1) Determining of the Context Information

It should be understood that, the context information is an input to OBUF, and is formed by a syntax element that has already been encoded. The context information may be classified into primary information and secondary information depending on importance of the information, where some information in the secondary information is reduced in the dynamic reducing process.

In an octree encoding framework, occupation information of a current encoding node is represented by an eight-bit binary code (occupation code). A sequence of the eight bits indicates an occupancy status of a child node at a specific location of the current node, where being occupied is represented by 1 and being unoccupied is represented by 0. An encoder currently used by GPCC is a context-based binary arithmetic encoder (CABAC). A current encoding symbol (bin) and a context model used for updating a probability are required to be input in encoding. Therefore, one bit of the eight-bit occupation code of the current node, namely, occupation information of one child node of the current node, is encoded each time.

A context of a to-be-encoded child node may be determined by using the following types of information: local sparsity of the to-be-encoded child node, location information of the to-be-encoded child node and an occupation status of an encoded sibling node, occupation statuses of six coplanar neighbors of the current node, and occupation statuses of other 20 co-edge and co-point neighbors of the current node. The context information is converted into a binary stream (bins), where information more relevant to the current child node is located in a higher bit of the bins as primary information, and information less relevant to the current child node is located in a lower bit of the bins as secondary information. The context information may be arranged in an order of importance as follows: an encoded sibling node of the current child node>an encoded coplanar child node neighbor of the current child node>an encoded co-edge child node neighbor of the current child node>an encoded co-point child node neighbor of the current child node>another encoded child node neighbor of the current child node>an encoded coplanar parent node neighbor of the current child node>an encoded co-edge parent node neighbor of the current child node>20 other encoded parent node neighbors.

During construction of the context information, different context models are first constructed for to-be-encoded child nodes, located at different locations, of the current node according to a scanning sequence. The scanning sequence is shown in FIG. 7. As a quantity of encoded child nodes in the current node increases, valid context information that may be referenced by a non-encoded child node also changes. In addition, there are different modes for determining local sparsity of the eight child nodes of the current node, so that each child node has its own context bin. The following will describe in detail a process of establishing the context information by using a child node 0 and a child node 1 as examples.

### Child Node 0

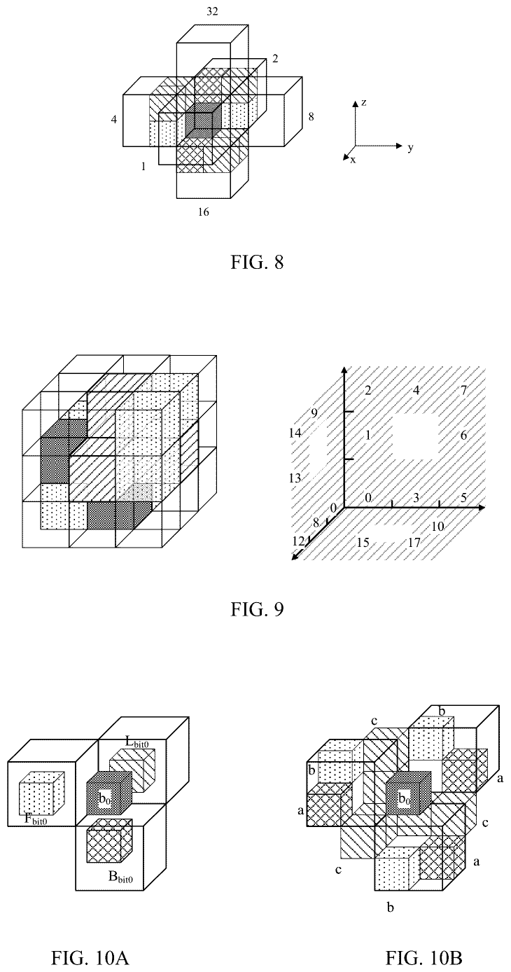

The child node 0 has a coplanar child node neighbor, a co-edge child node neighbor, and a co-point child node neighbor, and has no encoded sibling node. The child node 0 also has a coplanar parent node neighbor and 20 other encoded neighbor nodes that can be referenced. When it is determined to be sparse, the context bins include 19 bits, with a maximum of 219 states. The most significant 6 bits are used as primary information and the least significant 13 bits are used as non-reduced secondary information. When it is determined to be non-sparse, the context bins include 16 bits, with a maximum of 216 states. The most significant 4 bits are used as primary information and the lowest 12 bits as non-reduced secondary information. Local sparsity may be determined based on an occupation quantity (NN) of encoded 12 child nodes adjacent to the current child node in the negative x, y, and z directions in FIG. 8, where the occupation quantity NN>1 indicates being non-sparse, and the occupation quantity NN<1 indicates being sparse. In each state, the bins have a corresponding flag bit. For example, FIG. 8 is a schematic diagram showing distribution of child neighbor nodes and coplanar parent neighbor nodes of the child node 0, and FIG. 9 is a schematic diagram showing a distribution sequence of 20 parent neighbor nodes of the child node 0. Numbers such as 1, 2, 4, 8, 16, and 32 indicate serial numbers of the neighbor nodes.

In addition, Table 1 shows meaning of values of the bins corresponding to the child node 0, namely, the interpretation of context information of each bit in the bins, and an order from the most significant bit to the least significant bit reflects important of information. The flag bits are represented by 1 or 0 in gray cells. In addition, Table 1 also includes coplanar child nodes, co-edge child nodes, co-point child nodes, between-edge child nodes, co-bit child nodes, and the like. In Table 1, B(Bottom), F(Front), and L(left) are six-neighbor parent neighbor nodes numbered 16, 4, and 2, respectively, which are coplanar with the current node in FIG. 8. Because the three encoded nodes are located in a negative direction of a coordinate axis of the current node, occupation information of child nodes of the three encoded nodes may be obtained. Therefore, Table 1 lists each of coplanar child nodes, co-edge child nodes, and co-point child nodes of the current encoded child node in the three directions. Top, Back, and Right are six-neighbor parent neighbor nodes numbered 32, 8, and 1, respectively, which are coplanar with the current node in FIG. 8. Because the three encoded nodes are located in a positive direction of the coordinate axis of the current node, occupation information of child nodes of the three encoded nodes cannot be obtained, and correlation of the three encoded nodes is weaker than that of the foregoing 12 neighbor nodes. Other numbers such as 9, 4, 1, and 2 in Table 1 are sequence numbers of 20 co-edge/co-point neighbors of the current node except the six coplanar parent neighbors shown in FIG. 9.

It may be understood that, for “co-bit” child node information in Table 1, a child node whose number is 0 also exists in the encoded Bottom, Front, and Left nodes, and this node is referred to as a co-bit child node. In Table 1, LF, LB, and FB represented by two letters respectively denote occupation information (obtained through occupation code of a neighbor numbered 1 in the 20 neighbors) of two child nodes sharing an edge with the current child node and located between the Left and Front directions, occupation information (obtained through occupation code of a neighbor numbered 8 in the 20 neighbors) of two child nodes sharing an edge with the current child node and located between the Left and Bottom directions, and occupation information (obtained through occupation code of a neighbor numbered 3 in the 20 neighbors) of two child nodes sharing an edge with the current child node and located between the Front and Bottom directions.

Further, occupation information of 3*8=24 child nodes may be obtained by using occupation code of available parent neighbor nodes that are coplanar with the current child node in negative directions of the three coordinate axes, and 21 of the 24 child nodes are used for establishing context information of the child node bit0. The 21 nodes may be classified into the following five types (3+6+3+3+6=21) depending on a degree of correlation with the child node 0:
(1) child nodes coplanar with the current node, where there is one such child node in each of three directions: Bottom, Front and Left, represented by B_{face}, F_{face}, and L_{face}, respectively;
(2) child nodes co-edge with the current node, where there are two such child nodes in each of three directions: Bottom, Front and Left, represented by B²_{edge}, B¹_{edge}, F²_{face}, F¹_{face}, L²_{face}, and L¹_{face}, and a sequence of the two child nodes is determined by a scanning sequence;
(3) child nodes co-point with the current node, where there is one such child node in each of three directions: Bottom, Front and Left, represented by Bᵥₑᵣₜₑₓ, Fᵥₑᵣₜₑₓ, and Lᵥₑᵣₜₑₓ;
(4) child nodes co-bit with the current node, which are child nodes whose internal sequence numbers are 0 in the three directions: Bottom, Front, and Left, represented by B_{bit0}, F_{bit0}, and L_{bit0}, and specifically, as shown in FIG. 10A and FIG. 10B, the current node is represented by b₀; and
(5) child nodes that are coplanar with co-bit child nodes of the current node, namely, unclassified child nodes that are coplanar with co-bit child nodes in three directions: Bottom, Front, and Left, where there are two such child nodes in each of the three directions, represented by B²_{far}, B¹_{far}, F²_{far}, F¹_{far}, L²_{far}, and L¹_{far}.

Further, 26 parent neighbor nodes adjacent to the current node may be classified into the following five types (3+3+3+n+17−n) depending on a degree of correlation with the child node 0:
(1) three nodes that are coplanar with the current node and located in the negative directions of the coordinate axes, represented by Bottom, Front, and Left;
(2) three nodes that are coplanar with the current node and located in the positive directions of the coordinate axes, represented by Top, Back, and Right;
(3) three nodes that are co-edge with the current node and are located in the negative directions of the coordinate axes, numbered 1, 3, and 8 in the 20-neighbor graph, where information about another type of child nodes co-edge with the current node may be calculated by using occupation code of the three nodes, where there are two such other type child nodes in each of the three nodes, with 1 between Left and Front, 3 between Left and Bottom, and 8 between Front and Bottom, and information of the six child nodes is represented by LF²₁, LF¹₁, LB²₃, LB¹₃, FB²₈, FB¹₈;
(4) other parent neighbors participating in establishment of context information, where n parent neighbors are selected from the remaining 17 parent neighbors; and
(5) unused parent neighbor information, which is not used for predicting occupation status of the current child node, with a total quantity of 17−n.

### Child Node 1

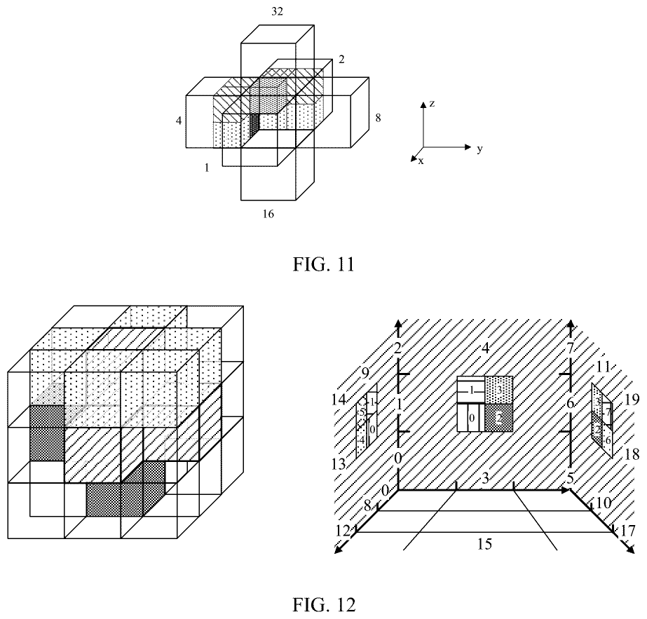

The child node 1 has a coplanar child node neighbor, a co-edge child node neighbor, and a co-point child node neighbor, including one encoded sibling node bit0. The child node 1 also has a coplanar parent node neighbor and 20 other encoded neighbor nodes that can be referenced. When it is determined to be sparse, the context bins include 19 bits, with a maximum of 219 states. The most significant 6 bits are used as primary information and the least significant 13 bits are used as non-reduced secondary information. When it is determined to be non-sparse, the context bins include 19 bits, with a maximum of 219 states. The most significant 7 bits are used as primary information and the least significant 12 bits as non-reduced secondary information. Local sparsity is determined based on an occupation quantity (NN) of encoded 4 child nodes adjacent to the current child node in the negative y direction in FIG. 11, where the occupation quantity NN>0 indicates being non-sparse, and the occupation quantity NN=0 indicates being sparse. For example, FIG. 11 is a schematic diagram showing distribution of child neighbor nodes and coplanar parent neighbor nodes of the child node 1, and FIG. 12 is a schematic diagram showing a distribution sequence of 20 parent neighbor nodes of the child node 1. Numbers such as 1, 2, 4, 8, 16, and 32 indicate serial numbers of the neighbor nodes.

In addition, Table 2 shows meaning of values of the bins corresponding to the child node 1, namely, the interpretation of context information of each bit in the bins. It may be learned from Table 2 that, an encoded sibling node 0 occupies most important information and is located at a most significant bit of the bins.

### (2) Dynamic Reducing Process/Update of Dynamic Reducing Process

In context information, primary information is not reduced, while secondary information is possible to be reduced. After a dynamic reducing process, remaining context information forms a context state D. Each context state D has a counter N, which is used to record a quantity of times a current state D has been accessed. If N is greater than a preset threshold, the dynamic reducing process is updated, that is, a syntax element to be encoded subsequently requires more secondary information to form a new context state D, which means that the reduced secondary information is dynamically adjusted.

In conclusion, it can be learned that an initial quantity of bits in context bins is large, which is generally 16 to 19 bits. If a quantity of context states is not decreased, a storage burden is caused. However, if a quantity of context states D is decreased in a manner of directly removing part of context information, accuracy of probability estimation is reduced. Therefore, the context information is required to be dynamically reduced, and the concept is to implicitly activate some states D. These states D[i₁][i₂′] are recombined contexts of fixed-bit primary information i₁ and secondary information i₂′ truncated by k bits in original context bins. The recombined contexts and a symbol currently to be encoded are input into an encoder to update probabilities of these states, and when access times of these states D are greater than a preset threshold (establishment of the preset threshold is related to probability update of the encoder), the secondary information truncated by k bits in the original context bins is changed to secondary information truncated by (k−1) bits, and the context is recombined again to activate a new state. This method of dynamically decreasing a quantity of states preserves all valid contexts while adaptively activating, using, and updating some of these states D.

This process requires additional introduction of k[i₁][i₂′] to record secondary information truncation bits and a counter N[i₁][i₂′] to record a usage frequency of recombined contexts, and thus memory overheads may be increased. Therefore, an embodiment of this application proposes a simplified process, that is, when secondary information reservation bits are greater than a value dₘₐₓ, a simplified counter N[i₁] is used, that is, only a use frequency of primary information is used as a basis for updating truncation of secondary information, and k[i₁] is used to record the secondary information truncation bits of the primary information. This hybrid dynamic reducing solution reduces implementation complexity while having original accuracy.

### (3) An Encoder Index Mapping Table and Update of the Mapping Table

Herein the encoder index mapping table provides a mapping relationship between a context state and an encoder index value. Based on the mapping table, an encoder index value that should be used by a to-be-encoded syntax element in any context state may be obtained. Each time when a syntax element is encoded, the mapping relationship between a context state D in the mapping table and an encoder index value is adjusted based on a result of the syntax element.

In a GPCC encoding framework, the encoder index mapping table may store an 8-bit encoder index value. When a symbol currently encoded is “1”, the encoder index value is increased (or remains unchanged). When a symbol currently encoded is “0”, the encoder index value is decreased (or unchanged). A specific update manner is as follows, where stateVal is an encoder index value, CtxMap is an encoder index mapping table, ctxMapIdx is a context state D, and binVal is a symbol currently encoded. Herein ctxMapTransition is a query table, as shown in Table 3, which shows values of ctxMapTransition[i].

For example, a specific update process is described as follows:

```
stateVal = CtxMap[ctxMapIdx]
if (bin Val)
  CtxMap[ctxMapIdx] += ctxMapTransition[(255−stateVal)>>4];
else
  CtxMap[ctxMapIdx] −= ctxMapTransition[stateVal>>4].
```

TABLE 3

| | i | | | | | | | | | | | | | | | |
|---|---|---|---|---|---|---|---|---|---|---|---|---|---|---|---|---|
| | 0 | 1 | 2 | 3 | 4 | 5 | 6 | 7 | 8 | 9 | 10 | 11 | 12 | 13 | 14 | 15 |
| Value | 0 | 1 | 1 | 2 | 4 | 7 | 9 | 11 | 14 | 16 | 19 | 23 | 22 | 22 | 20 | 15 |

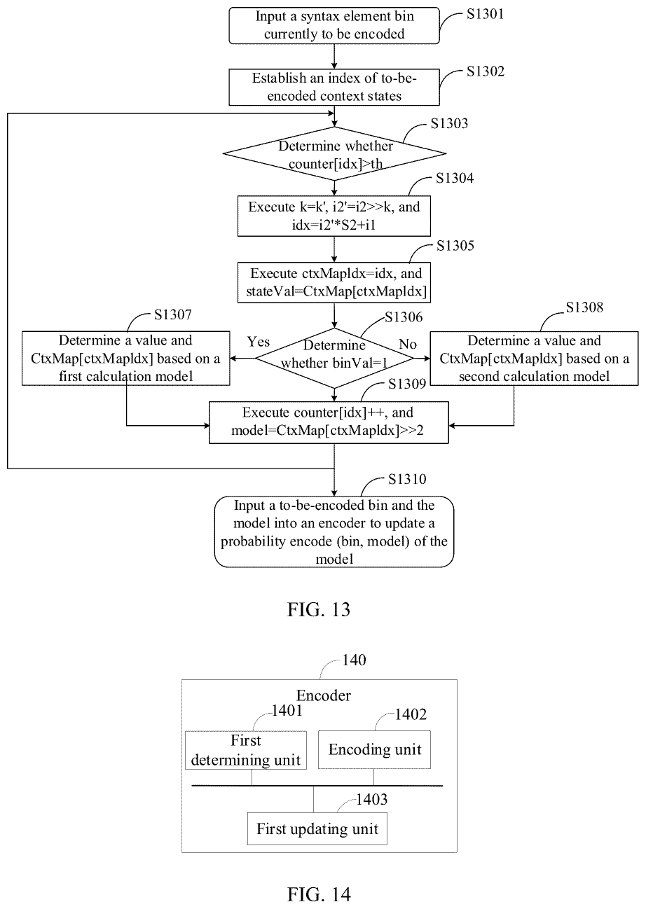

After state Val is obtained, an encoder corresponding to the symbol currently to be encoded may be obtained, and the encoder index value may be in a one-to-one correspondence with the encoder. Mapping may be further performed, and a plurality of encoder index values correspond one encoder, so as to obtain a final encoder index value. For example, in the GPCC encoding framework, state Val is required to be shifted by 2 bits to obtain a final encoder index value. For example, as shown in FIG. 13, the process may specifically include the following steps:

S1301: A syntax element bin currently to be encoded is input.

S1302: An index of a to-be-encoded context state is established.

Specifically, in embodiments of this application, S1=1<<userBitS1,1<<userBitS2); i2′=i2>>k; idx=i2′*S2+i1.

S1303: Whether counter[idx]>th is determined.

S1304: k=k′, i2′=i2>>k, and idx=i2′*S2+i1 are executed.

S1305: ctxMapldx=idx, and state Val-CtxMap[ctxMapldx] are executed.

S1306: Whether bin Val=1 is determined.

S1307: A value and CtxMap[ctxMapldx] are determined based on a first calculation model.

S1308: A value and CtxMap[ctxMapldx] are determined based on a second calculation model.

S1309: counter[idx]++ and model=CtxMap[ctxMapldx]>>2 are executed.

S1310: A to-be-encoded bin and the model are input into an encoder to update a probability encode (bin, model) of the model.

Specifically, in embodiments of this application, for S1306, if a determining result is yes, S1307 is performed. In this case, the first calculation model is value=ctxMap Transition[(255−stateVal)>>4], and CtxMap[ctxMapldx]=CtxMap[ctxMapldx]+value. If the determining result is no, S1308 is performed. In this case, the second calculation model is value=ctxMapTransition[(255−stateVal)>>4], and CtxMap[ctxMapldx]=CtxMap[ctxMapldx]−value.

### (4) Update of a Probability of the Encoder

After a binary syntax element is encoded, a probability value of the encoder is also updated. If the probability value of the encoder represents a probability of the symbol “0”, when a binary syntax element currently encoded is 0, the probability value of the encoder is increased (or remains unchanged); when a binary syntax element currently encoded is 1, a probability value of the encoder is decreased (or remains unchanged). Alternatively, if the probability value of the encoder represents a probability of the symbol “1”, when a binary syntax element currently to be encoded is 0, a probability value of the encoder is decreased (or remains unchanged); when a binary syntax element currently to be encoded is 0, a probability value of the encoder is increased (or remains unchanged).

In the GPCC encoding framework, a probability value of the encoder represents a probability of the symbol “0”, the probability value of the encoder increases (or remains unchanged) after the encoded symbol “0”, and decreases (or remains unchanged) after the encoded symbol “1”. A specific update manner is as follows: binVal represents an encoded symbol, pro represents a probability value stored in the encoder, and CtxUpdateDelta is a look up table, as shown in Table 4, which shows values of CtxUpdateDelta[i+j].

For example, a specific update process is described as follows:

if (binVal)
pro−= CtxUpdateDelta[pro>>8];
else
pro += CtxUpdateDelta[255 − (pro>>8)].

TABLE 4

| | i | | | | | | | | | | | |
|---|---|---|---|---|---|---|---|---|---|---|---|---|
| j | 0 | 1 | 2 | 3 | 4 | 5 | 6 | 7 | 8 | 9 | 10 | 11 |
| 0 | 0 | 2 | 5 | 8 | 11 | 15 | 20 | 24 | 29 | 35 | 41 | 47 |
| 12 | 53 | 60 | 67 | 74 | 82 | 89 | 97 | 106 | 114 | 123 | 132 | 141 |
| 24 | 150 | 160 | 170 | 180 | 190 | 201 | 211 | 222 | 233 | 244 | 256 | 267 |
| 36 | 279 | 291 | 303 | 315 | 327 | 340 | 353 | 366 | 379 | 392 | 405 | 419 |
| 48 | 433 | 447 | 461 | 475 | 489 | 504 | 518 | 533 | 548 | 563 | 578 | 593 |
| 60 | 609 | 624 | 640 | 656 | 672 | 688 | 705 | 721 | 738 | 754 | 771 | 788 |
| 72 | 805 | 822 | 840 | 857 | 875 | 892 | 910 | 928 | 946 | 964 | 983 | 1001 |
| 84 | 1020 | 1038 | 1057 | 1076 | 1095 | 1114 | 1133 | 1153 | 1172 | 1192 | 1211 | 1231 |
| 96 | 1251 | 1271 | 1291 | 1311 | 1332 | 1352 | 1373 | 1393 | 1414 | 1435 | 1456 | 1477 |
| 108 | 1498 | 1520 | 1541 | 1562 | 1584 | 1606 | 1628 | 1649 | 1671 | 1694 | 1716 | 1738 |
| 120 | 1760 | 1783 | 1806 | 1828 | 1851 | 1874 | 1897 | 1920 | 1935 | 1942 | 1949 | 1955 |
| 132 | 1961 | 1968 | 1974 | 1980 | 1985 | 1991 | 1996 | 2001 | 2006 | 2011 | 2016 | 2021 |
| 144 | 2025 | 2029 | 2033 | 2037 | 2040 | 2044 | 2047 | 2050 | 2053 | 2056 | 2058 | 2061 |
| 156 | 2063 | 2065 | 2066 | 2068 | 2069 | 2070 | 2071 | 2072 | 2072 | 2072 | 2072 | 2072 |
| 168 | 2072 | 2071 | 2070 | 2069 | 2068 | 2066 | 2065 | 2063 | 2060 | 2058 | 2055 | 2052 |
| 180 | 2049 | 2045 | 2042 | 2038 | 2033 | 2029 | 2024 | 2019 | 2013 | 2008 | 2002 | 1996 |
| 192 | 1989 | 1982 | 1975 | 1968 | 1960 | 1952 | 1943 | 1934 | 1925 | 1916 | 1906 | 1896 |
| 204 | 1885 | 1874 | 1863 | 1851 | 1839 | 1827 | 1814 | 1800 | 1786 | 1772 | 1757 | 1742 |
| 216 | 1727 | 1710 | 1694 | 1676 | 1659 | 1640 | 1622 | 1602 | 1582 | 1561 | 1540 | 1518 |
| 228 | 1495 | 1471 | 1447 | 1422 | 1396 | 1369 | 1341 | 1312 | 1282 | 1251 | 1219 | 1186 |
| 240 | 1151 | 1114 | 1077 | 1037 | 995 | 952 | 906 | 857 | 805 | 750 | 690 | 625 |
| 252 | 553 | 471 | 376 | 255 | | | | | | | | |

Further, in embodiments of this application, a plurality of encoders are included in the encoder index mapping table, and each encoder index value may correspond to a respective encoder. For a plurality of used encoders (assuming that there are K encoders), index values thereof range from 0 to K−1. Initial values T_0, T₁ . . . Tᵢ . . . T_{K-1} of probability values are assigned to the K encoders, and an initial value is a number in a range of [0, 1]. If a 16-bit unsigned integer is used for representing and storage, a value range is from 0 to 65535. During encoding of a binary symbol, when both the probability value of the encoder and corresponding index in the mapping table increases (or remains unchanged) or decreases (remains unchanged), it is considered that an update direction of probabilities of the encoder is the same as an update direction of the index mapping table, otherwise, it is considered that the update directions are opposite to each other. If the update direction of probabilities of the encoder is opposite to an update direction of the index mapping table, the initial value should meet: T₀≥T₁≥ . . . ≥Tᵢ≥ . . . ≥T_{K-2}≥T_{K-1}; if the update direction of probabilities of the encoder is the same as the update direction of the index mapping table, the initial value should meet: T₀≤T₁≤ . . . ≤Tᵢ≤ . . . ≤T_{K-2}≤T_{K-1}.

In a conventional technology, namely, in a general test software TMC13 v19 of G-PCC, a value of K is 64, and when the update direction of probabilities of the encoder is opposite to the update direction of the index mapping table, initial values of probabilities of the 64 encoders may be set as follows:

```
  int coder_init_pro[64]={
65517,65444,65294,65066,64761,64379,63922,63390,62783,
62104,61355,60537,59653,58704,57692,
56620,55490,54305,53068,51782,50451,49076,47663,46213,
44731,43220,41683,40124,38548,36958,
35357,33750,32141,30533,28930,27335,25754,24190,22646,
21127,19635,18175,16750,15364,14020,
12721,11470,10270,9125,8038,7009,6042,5140,4305,3540,
2845,2222,1674,1202,806,488,249,91,16
  };
```

Further, in embodiments of this application, a threshold parameter may be further set for the probability values of the encoder.

(a) For used K encoders, two thresholds are set for the probability value Pₖ: lower threshold Lᵢ and upper threshold Uᵢ, which should meet Lᵢ≤Uᵢ. After probability update is performed, Pₖ=Clip3(Lᵢ, Uᵢ, Pᵢ) is further performed on the probability value Pₖ of the encoder, where Clip3(x, y, z) is a truncation calculation function, and the calculation formula thereof is shown in the formula (1).

(b) The lower threshold Lᵢ and the upper threshold Uᵢ of the K encoders are also required to be meet the following:
if the update direction of probabilities of the encoder is opposite to the update direction of the index mapping table, L₀≥L₁≥ . . . ≥Lᵢ≥ . . . ≥L_{K-2}≥L_{K-1}, and U₀≥U₁≥ . . . ≥Uᵢ≥ . . . ≥U_{K-2}≥U_{K-1};

if the update direction of probabilities of the encoder is the same as the update direction of the index mapping table, L₀≤L₁≤ . . . ≤Lᵢ≤ . . . ≤L_{K-2}≤L_{K-1}, and U₀≤U₁≤ . . . ≤Uᵢ≤ . . . ≤U_{K-2}≤U_{K-1};

In the general test software TMC13 v19 of the G-PCC, the probability value stored in the encoder is a probability value of the symbol “0” with 16-bit precision. Therefore, the lower threshold Lᵢ and the upper threshold Uᵢ should meet: L₀≥L₁≥ . . . ≥Lᵢ≥ . . . ≥L_{K-2}≥L_{K-1} and U₀≥U₁≥ . . . ≥Uᵢ≥ . . . ≥U_{K-2}≥U_{K-1}.

(c) The upper threshold and lower threshold of the K encoders should meet that an upper threshold of an encoder is the same as a lower threshold of an adjacent encoder, and a lower threshold of the encoder is the same as an upper threshold of the adjacent encoder. Details are as follows:
if the update direction of the probabilities of the encoder is opposite to the update direction of the index mapping table, Lᵢ and Uᵢ should meet: Lᵢ=Uᵢ₊₁ (0≤i≤K−2);
if the update direction of the probabilities of the encoder is the same as the update direction of the index mapping table, Lₖ and Uₖ should meet: Uᵢ=Lᵢ₊₁ (0≤i≤K−2).

With reference to the foregoing three requirements, the upper threshold and the lower threshold of 64 encoders may be set as follows:

```
int coder_bound = {
  {65500, 65535}, {65388, 65500}, {65200, 65388}, {64933, 65388},
  {64590, 64933}, {64169, 64590}, {63675, 64169}, {63105, 63675},
  {62462, 63105}, {61747, 62462}, {60963, 61747}, {60112, 60963},
  {59194, 60112}, {58214, 59194}, {57171, 58214}, {56069, 57171},
  {54911, 56069}, {53699, 54911}, {52437, 53699}, {51128, 52437},
  {49774, 51128}, {48379, 49774}, {46947, 48379}, {45480, 46947},
  {43983, 45480}, {42458, 43983}, {40908, 42458}, {39340, 40908},
  {37756, 39340}, {36160, 37756}, {34555, 36160}, {32946, 34555},
  {31336, 32946}, {29730, 31336}, {28130, 29730}, {26541, 28130},
  {24967, 26541}, {23413, 24967}, {21880, 23413}, {20374, 21880},
  {18897, 20374}, {17454, 18897}, {16047, 17454}, {14681, 16047},
  {13359, 14681}, {12083, 13359}, {10857, 12083}, {9684, 10857},
  {8567, 9684}, {7509, 8567}, {6510, 7509}, {5575, 6510},
  {4706, 5575}, {3905, 4706}, {3175, 3905}, {2515, 3175},
  {1930, 2515}, {1419, 1930}, {985, 1419}, {627, 985},
  {349, 627}, {150, 349}, {32, 150}, {0,32}};
```

(d) The upper threshold Uᵢ and the lower threshold Lᵢ of each encoder may be dynamically updated and adjusted, as long as the following are met after the update: L₀≥L₁≥ . . . ≥Lᵢ≥ . . . ≥L_{K-2}≥L_{K-1}, and U₀≥U₁≥ . . . ≥Uᵢ≥ . . . ≥U_{K-2}≥U_{K-1}; or L₀≤L₁≤ . . . ≤Lᵢ≤ . . . ≤L_{K-2}≤L_{K-1}, and U₀≤U₁≤ . . . ≤Uᵢ≤ . . . ≤U_{K-2}≤U_{K-1}.

In this way, based on the general test software TMC13 V19 of the G-PCC, a probability initial value and upper and lower thresholds are set according to the technical solution in embodiments of this application. Comparison between the TMC13 v19 in the conventional technology and the above technical solution in performance of lossless geometric bitstream is shown in Table 5. It may be learned from Table 5 that, in the above technical solution, there is an average gain of about 1.1% on the geometry bitstream of the data, which reduces encoding bits.

TABLE 5

| Sequence | bpip ratio [%] |
|---|---|
| basketball_player_vox11_00000200 | 98.9% |
| dancer_vox11_00000001 | 98.8% |
| facade_00064_vox11 | 98.8% |
| longdress_vox10_1300 | 98.8% |
| loot_vox10_1200 | 98.7% |
| queen_0200 | 98.8% |
| redandblack_vox10_1550 | 99.3% |
| soldier_vox10_0690 | 98.7% |
| thaidancer_viewdep_vox12 | 99.2% |
| Average value | 98.9% |

In embodiments of this application, specific implementations of the foregoing embodiments are described in detail through the embodiments described above, from which it can be learned that, since candidate data processing modes meet a first preset condition of an initialization parameter, an upper limit threshold parameter, a lower limit threshold parameter or the like, in an encoding process, an optimal target encoder can be selected from the candidate data processing modes for encoding, so that a bit rate can be reduced and coding efficiency can be improved, thereby further improving coding performance.

In still another embodiment of this application, based on a same invention concept of foregoing embodiments, FIG. 14 is a schematic diagram of a structure of an encoder 140 according to an embodiment of this application. As shown in FIG. 14, the encoder 140 may include a first determining unit 1401 and an encoding unit 1402.

The first determining unit 1401 is configured to: determine candidate data processing modes based on a first preset condition 1401, and determine a data processing mode parameter corresponding to a to-be-encoded syntax element.

The first determining unit 1401 is further configured to determine a target data processing mode based on the candidate data processing modes and the data processing mode parameter.

The encoding unit 1402 is configured to: encode a value of the to-be-encoded syntax element based on the target data processing mode, and write the encoded value into a bitstream.

It should be noted that, in embodiments of this application, the encoder 140 may also be considered as a data processing mode (or “entropy encoder”), and is configured to encode the value of the to-be-encoded syntax element.

In some embodiments, the first determining unit 1401 is further configured to determine initialization parameters of the candidate data processing modes based on the first preset condition.

In some embodiments, the initialization parameters indicate probability values of the candidate data processing modes.

In some embodiments, the first determining unit 1401 is further configured to determine threshold parameters of the candidate data processing modes according to the first preset condition.

In some embodiments, each of the threshold parameters indicates a probability threshold of a respective candidate data processing mode, and the probability threshold includes an upper probability limit and/or a lower probability limit.

In some embodiments, the first determining unit 1401 is further configured to determine a first sorting indication parameter based on the initialization parameters of the candidate data processing modes.

In some embodiments, values of the first sorting indication parameter may include a first preset value and a second preset value. The first preset value indicates a descending order of initialization parameters, and the second preset value indicates an ascending order of initialization parameters.

In some embodiments, the first determining unit 1401 is further configured to: determine a third preset value and a fourth preset value of the candidate data processing modes; and determine a value of the first sorting indication parameter based on the third preset value and the fourth preset value. The third preset value indicates an update order of probability values of the candidate data processing modes, and the fourth preset value indicates an update order of index values of the candidate data processing modes.

In some embodiments, the first determining unit 1401 is further configured to: determine that the value of the first sorting indication parameter is the first preset value in a case that the third preset value is different from the fourth preset value; determine that the value of the first sorting indication parameter is the second preset value in a case that the third preset value is the same as the fourth preset value.

In some embodiments, the first determining unit 1401 is further configured to: determine a first parameter corresponding to the candidate data processing modes; and determine the value of the first sorting indication parameter based on the first parameter.

In some embodiments, the first determining unit 1401 is further configured to: determine that the value of the first sorting indication parameter is the first preset value in a case that the first parameter indicates first data; determine that the value of the first sorting indication parameter is the second preset value in a case that the first parameter indicates second data.

In some embodiments, the first determining unit 1401 is further configured to: when the value of the first sorting indication parameter is the first preset value, Tᵢ₋₁ is greater than or equal to Tᵢ; when the value of the first sorting indication parameter is the second preset value, Tᵢ₋₁ is less than or equal to Tᵢ. Herein Tᵢ is an initialization parameter of a candidate data processing mode, i=1, 2, . . . , K−1, and K represents a quantity of the candidate data processing modes.

In some embodiments, the first determining unit 1401 is further configured to determine a second sorting indication parameter based on the threshold parameters of the candidate data processing modes.

In some embodiments, values of the second sorting indication parameter include a fifth preset value and a sixth preset value. The fifth preset value indicates a descending order of threshold parameters, and the sixth preset value indicates an ascending order of the threshold parameters.

In some embodiments, the first determining unit 1401 is further configured to: determine a third preset value and a fourth preset value of the candidate data processing modes; and determine a value of the second sorting indication parameter based on the third preset value and the fourth preset value. The third preset value indicates an update order of probability values of the candidate data processing modes, and the fourth preset value indicates an update order of index values of the candidate data processing modes.

In some embodiments, the first determining unit 1401 is further configured to: determine that the value of the second sorting indication parameter is the fifth preset value in a case that the third preset value is different from the fourth preset value; determine that the value of the second sorting indication parameter is the sixth preset value in a case that the third preset value is the same as the fourth preset value.

In some embodiments, the first determining unit 1401 is further configured to: determine a first parameter corresponding to the candidate data processing modes; and determine a value of the second sorting indication parameter based on the first parameter.

In some embodiments, the first determining unit 1401 is further configured to: determine that the value of the second sorting indication parameter is the fifth preset value in a case that the first parameter indicates first data; determine that the value of the second sorting indication parameter is the sixth preset value in a case that the first parameter indicates second data.

In some embodiments, the first determining unit 1401 is further configured to: when the value of the second sorting indication parameter is the fifth preset value, in a case that the threshold parameter is a lower limit threshold parameter, determine that Lᵢ₋₁ is greater than or equal to Lᵢ; in a case that the threshold parameter is an upper limit threshold parameter, determine that Uᵢ₋₁ is greater than or equal to Uᵢ; and when the value of the second sorting indication parameter is the sixth preset value, in a case that the threshold parameter is a lower limit threshold parameter, determine that Lᵢ₋₁ is less than or equal to Lᵢ; in a case that the threshold parameter is an upper limit threshold parameter, determine that Uᵢ₋₁ is less than or equal to Uᵢ. Herein Lᵢ is a lower limit threshold parameter of a candidate data processing mode, Uᵢ is an upper limit threshold parameter of a candidate data processing mode, i=1, 2, . . . , K−1, and K represents a quantity of the candidate data processing modes.

In some embodiments, the first determining unit 1401 is further configured to: in the candidate data processing modes, determine that a lower limit threshold parameter of a current candidate data processing mode is the same as an upper limit threshold parameter of an adjacent candidate data processing mode, and determine that an upper limit threshold parameter of the current candidate data processing mode is the same as a lower limit threshold parameter of the adjacent candidate data processing mode.

In some embodiments, the first determining unit 1401 is further configured to: determine that Lᵢ₋₁=Uᵢ in a case that the third preset value is different from the fourth preset value; and determine that Uᵢ₋₁=Lᵢ in a case that the third preset value is the same as the fourth preset value.

In some embodiments, referring to FIG. 14, the encoder 140 may further include a first updating unit 1403, configured to: adjust threshold parameters of the candidate data processing modes to determine adjusted threshold parameters of the candidate data processing modes. When the value of the second sorting indication parameter is the fifth preset value, the second sorting indication parameter indicates a descending order of the adjusted threshold parameters; when the value of the second sorting indication parameter is the sixth preset value, the second sorting indication parameter indicates an ascending order of the adjusted threshold parameters.

In some embodiments, the first determining unit 1401 is further configured to: determine context information of the to-be-encoded syntax element; and determine the data processing mode parameter based on the context information and a preset mapping table.

In some embodiments, the first determining unit 1401 is further configured to: determine a context state of the to-be-encoded syntax element based on the context information; and determine the data processing mode parameter based on the context state and the preset mapping table. The preset mapping table is used for representing a mapping relationship between a context state and a data processing mode parameter.

In some embodiments, the first updating unit 1403 is further configured to update the preset mapping table based on the value of the to-be-encoded syntax element.

In some embodiments, the first updating unit 1403 is further configured to: in a case that the value of the to-be-encoded syntax element is a seventh preset value, decrease the data processing mode parameter in the preset mapping table; in a case that the value of the to-be-encoded syntax element is an eighth preset value, increase the data processing mode parameter in the preset mapping table.

In some embodiments, the first updating unit 1403 is further configured to: determine a first probability value of the target data processing mode based on the value of the to-be-encoded syntax element; and update the first probability value of the target data processing mode to determine a second probability value of the target data processing mode.

In some embodiments, the first determining unit 1401 is further configured to determine a second parameter corresponding to the target data processing mode.

The first updating unit 1403 is further configured to: update the first probability value of the target data processing mode based on the second parameter and the value of the to-be-encoded syntax element, to determine the second probability value of the target data processing mode.

In some embodiments, the first updating unit 1403 is further configured to: increase the first probability value of the target data processing mode in a case that the second parameter indicates first data and the value of the to-be-encoded syntax element is a seventh preset value; decrease the first probability value of the target data processing mode in a case that the second parameter indicates first data and the value of the to-be-encoded syntax element is an eighth preset value; or decrease the first probability value of the target data processing mode in a case that the second parameter indicates second data, and a symbol of the to-be-encoded syntax element is a seventh preset value; increase the first probability value of the target data processing mode in a case that the second parameter indicates second data and the symbol of the to-be-encoded syntax element is an eighth preset value.

In some embodiments, the first determining unit 1401 is further configured to modify the second probability value of the target data processing mode to determine a target probability value of the target data processing mode.

In some embodiments, the first determining unit 1401 is further configured to: set the target probability value to the lower probability limit in a case that the second probability value is less than the lower probability limit; set the target probability value to the upper probability limit in a case that the second probability value is greater than the upper probability limit; or set the target probability value to the second probability value in a case that the second probability value is greater than or equal to the lower probability limit and less than or equal to the upper probability limit.

It may be understood that, in embodiments of this application, the term “unit” may be a partial circuit, a partial processor, a partial program or software, or the like. Certainly, the term “unit” may be a module or may be in a non-modular form. In addition, component parts in embodiments may be integrated into one processing unit, or each of the units may exist alone physically, or two or more units may be integrated into one unit. The foregoing integrated unit may be implemented in a form of hardware, or may be implemented in a form of a software functional module.

When the integrated unit is implemented in a form of a software functional module and not sold or used as an independent product, the integrated unit may be stored in a computer-readable storage medium. Based on such an understanding, the technical solutions of embodiments essentially, or the part contributing to the conventional technology, or all or a part of the technical solutions may be implemented in a form of a software product. The computer software product is stored in a storage medium and includes several instructions for instructing a computer device (which may be a personal computer, a server, or a network device) or a processor (processor) to execute all or a part of the steps of the methods described in the embodiments. The foregoing storage medium includes various media that may store a program code, such as a USB flash drive, a removable hard disk, a read-only memory (Read-only Memory, ROM), a random access memory (Random Access Memory, RAM), a magnetic disk, or an optical disk.

Therefore, an embodiment of this application provides a computer-readable storage medium, applied to an encoder 140. The computer-readable storage medium stores a computer program, and the computer program is executed by a first processor to implement the encoding method according to any one of the foregoing embodiments.

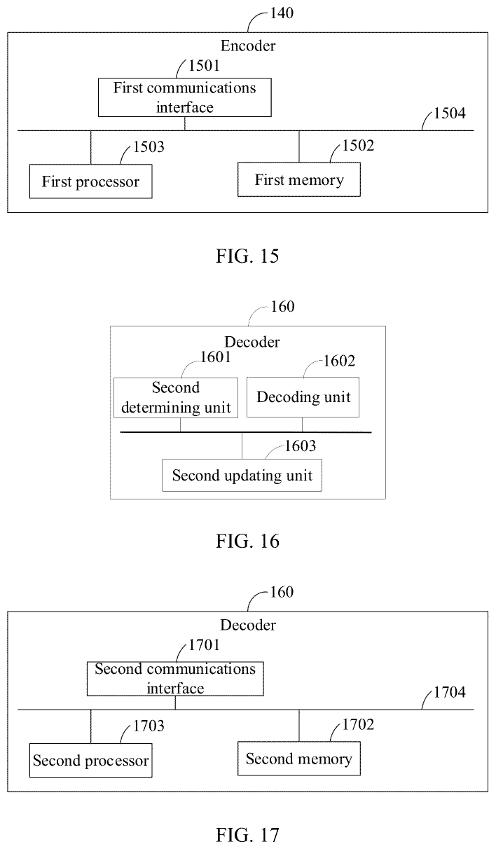

Based on the structure of the encoder 140 and the computer-readable storage medium, referring to FIG. 15, FIG. 15 is a schematic diagram of a hardware structure the encoder 140 according to an embodiment of this application. As shown in FIG. 15, the encoder 140 may include a first communications interface 1501, a first memory 1502, and a first processor 1503. The components are coupled together by using a first bus system 1504. It may be understood that the first bus system 1504 is configured to implement connection and communication between these components. The first bus system 1504 may further include a power bus, a control bus, a status signal bus, and the like in addition to a data bus. However, for clarity of description, various buses are marked as the first bus system 1504 in FIG. 15.

The first communications interface 1501 is configured to receive and transmit signals in the process of transmitting and receiving information with other external network elements.

The first memory 1502 is configured to store a computer program runnable on the first processor 1503.

The first processor 1503 is configured to run the computer program to perform the following operations:
determining candidate data processing modes based on a first preset condition;
determining a data processing mode parameter corresponding to a to-be-encoded syntax element;
determining a target data processing mode based on the candidate data processing modes and the data processing mode parameter; and
encoding a value of the to-be-encoded syntax element based on the target data processing mode, and writing the encoded value into a bitstream.

It may be understood that, in embodiments of this application, the first memory 1502 may be a volatile memory or a non-volatile memory, or may include both a volatile memory and a non-volatile memory. The non-volatile memory may be a read-only memory (Read-Only Memory, ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (Random Access Memory, RAM), and is used as an external cache. By way of example rather than limitative description, many forms of RAMs are available, for example, a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synchlink dynamic random access memory (Synchlink DRAM, SLDRAM), and a direct Rambus random access memory (Direct Rambus RAM, DRRAM). The first memory 1502 in the systems and the methods described in this application include but are not limited to these and any memory of another appropriate type.

The first processor 1503 may be an integrated circuit chip having a signal processing capability. In an implementation process, steps in the foregoing methods may be implemented by using a hardware integrated logical circuit in the first processor 1503, or by using instructions in a form of software. The first processor 1503 may be a general-purpose processor, a digital signal processor (Digital Signal Processor, DSP), an application-specific integrated circuit (Application Specific Integrated Circuit, ASIC), a field programmable gate array (Field Programmable Gate Array, FPGA) or another programmable logic device, a discrete gate or a transistor logic device, or a discrete hardware component. The first processor 1503 may implement or execute the methods, steps, and logical block diagrams disclosed in embodiments of this application. The general-purpose processor may be a microprocessor, or the processor may be any conventional processor or the like. The steps of the methods disclosed with reference to embodiments of this application may be directly implemented by a hardware decoding processor, or may be implemented by a combination of hardware and software modules in a decoding processor. The software module may be located in a mature storage medium in the art, for example, a random access memory, a flash memory, a read-only memory, a programmable read-only memory, an erasable programmable memory, or a register. The storage medium is located in the first memory 1502, and the first processor 1503 reads information in the first memory 1502 and completes the steps of the foregoing methods in combination with hardware of the first processor.

It may be understood that these embodiments described in this application may be implemented by hardware, software, firmware, middleware, microcode, or a combination thereof. For hardware implementation, the processing unit may be implemented in one or more application-specific integrated circuits (Application Specific Integrated Circuits, ASIC), digital signal processors (Digital Signal Processing, DSP), digital signal processing devices (DSP Device, DSPD), programmable logic devices (Programmable Logic Device, PLD), field programmable gate arrays (Field-Programmable Gate Array, FPGA), general-purpose processors, controllers, microcontrollers, microprocessors, and other electronic units configured to perform the functions described in this application, or a combination thereof. For software implementation, the techniques described in this application can be implemented by modules (such as processes and functions) that perform the functions described in this application. Software code may be stored in a memory and executed by a processor. The memory can be implemented in the processor or outside the processor.

Optionally, in another embodiment, the first processor 1503 is further configured to run the computer program to perform the encoding method according to any one of the foregoing embodiments.

This embodiment provides an encoder. In the encoder, since the candidate data processing modes meet the first preset condition of an initialization parameter, an upper limit threshold parameter, a lower limit threshold parameter or the like, in an encoding process, an optimal target encoder can be selected from the candidate data processing modes for encoding, so that a bit rate can be reduced and coding efficiency can be improved, thereby further improving coding performance.

In still another embodiment of this application, based on a same invention concept of foregoing embodiments, FIG. 16 is a schematic diagram of a structure of a decoder 160 according to an embodiment of this application. As shown in FIG. 16, the decoder 160 may include a second determining unit 1601 and a decoding unit 1602.

The second determining unit 1601 is configured to: determine candidate data processing modes based on a first preset condition, and determine a data processing mode parameter corresponding to a to-be-decoded syntax element.

The second determining unit 1601 is further configured to determine a target data processing mode based on the candidate data processing modes and the data processing mode parameter.

The decoding unit 1602 is configured to decode the to-be-decoded syntax element based on the target data processing mode to determine a value of the to-be-decoded syntax element.

It should be noted that, in embodiments of this application, the decoder 160 may also be considered as a data processing mode (or “entropy decoder”), and is configured to decode the value of the to-be-decoded syntax element.

In some embodiments, the second determining unit 1601 is further configured to determine initialization parameters of the candidate data processing modes based on the first preset condition.

In some embodiments, the initialization parameters indicate probability values of the candidate data processing modes.

In some embodiments, the second determining unit 1601 is further configured to determine threshold parameters of the candidate data processing modes based on the first preset condition.

In some embodiments, each of the threshold parameters indicates a probability threshold of a respective candidate data processing mode, and the probability threshold includes an upper probability limit and/or a lower probability limit.

In some embodiments, the second determining unit 1601 is further configured to determine a first sorting indication parameter based on the initialization parameters of the candidate data processing modes.

In some embodiments, values of the first sorting indication parameter may include a first preset value and a second preset value. The first preset value indicates a descending order of initialization parameters, and the second preset value indicates an ascending order of initialization parameters.

In some embodiments, the second determining unit 1601 is further configured to: determine a third preset value and a fourth preset value of the candidate data processing modes; and determine a value of the first sorting indication parameter based on the third preset value and the fourth preset value. The third preset value indicates an update order of probability values of the candidate data processing modes, and the fourth preset value indicates an update order of index values of the candidate data processing modes.

In some embodiments, the second determining unit 1601 is further configured to: determine that the value of the first sorting indication parameter is the first preset value in a case that the third preset value is different from the fourth preset value; determine that the value of the first sorting indication parameter is the second preset value in a case that the third preset value is the same as the fourth preset value.

In some embodiments, the second determining unit 1601 is further configured to: determine a first parameter corresponding to the candidate data processing modes; and determine the value of the first sorting indication parameter based on the first parameter.

In some embodiments, the second determining unit 1601 is further configured to: determine that the value of the first sorting indication parameter is the first preset value in a case that the first parameter indicates first data; determine that the value of the first sorting indication parameter is the second preset value in a case that the first parameter indicates second data.

In some embodiments, the second determining unit 1601 is further configured to: determine that Tᵢ₋₁ is greater than or equal to Tᵢ when the value of the first sorting indication parameter is the first preset value; determine that Tᵢ₋₁ is less than or equal to Tᵢ when the value of the first sorting indication parameter is the second preset value. Herein Tᵢ is an initialization parameter of a candidate data processing mode, i=1, 2, . . . , K−1, and K represents a quantity of the candidate data processing modes.

In some embodiments, the second determining unit 1601 is further configured to determine a second sorting indication parameter based on the threshold parameters of the candidate data processing modes.

In some embodiments, values of the second sorting indication parameter include a fifth preset value and a sixth preset value. The fifth preset value indicates a descending order of threshold parameters, and the sixth preset value indicates an ascending order of the threshold parameters.

In some embodiments, the second determining unit 1601 is further configured to: determine a third preset value and a fourth preset value of the candidate data processing modes; and determine a value of the second sorting indication parameter based on the third preset value and the fourth preset value. The third preset value indicates an update order of probability values of the candidate data processing modes, and the fourth preset value indicates an update order of index values of the candidate data processing modes.

In some embodiments, the second determining unit 1601 is further configured to: determine that the value of the second sorting indication parameter is the fifth preset value in a case that the third preset value is different from the fourth preset value; determine that the value of the second sorting indication parameter is the sixth preset value in a case that the third preset value is the same as the fourth preset value.

In some embodiments, the second determining unit 1601 is further configured to: determine a first parameter corresponding to the candidate data processing modes; and determine a value of the second sorting indication parameter based on the first parameter.

In some embodiments, the second determining unit 1601 is further configured to: determine that the value of the second sorting indication parameter is the fifth preset value in a case that the first parameter indicates first data; determine that the value of the second sorting indication parameter is the sixth preset value in a case that the first parameter indicates second data.

In some embodiments, the second determining unit 1601 is further configured to: when the value of the second sorting indication parameter is the fifth preset value, in a case that the threshold parameter is a lower limit threshold parameter, determine that Lᵢ₋₁ is greater than or equal to Lᵢ; in a case that the threshold parameter is an upper limit threshold parameter, determine that Uᵢ₋₁ is greater than or equal to Uᵢ; and when the value of the second sorting indication parameter is the sixth preset value, in a case that the threshold parameter is a lower limit threshold parameter, determine that Lᵢ₋₁ is less than or equal to Lᵢ; in a case that the threshold parameter is an upper limit threshold parameter, determine that Uᵢ₋₁ is less than or equal to Uᵢ. Herein Lᵢ is a lower limit threshold parameter of a candidate data processing mode, Uᵢ is an upper limit threshold parameter of a candidate data processing mode, i=1, 2, . . . , K−1, and K represents a quantity of the candidate data processing modes.

In some embodiments, the second determining unit 1601 is further configured to: in the candidate data processing modes, determine that a lower limit threshold parameter of a current candidate data processing mode is the same as an upper limit threshold parameter of an adjacent candidate data processing mode, and determine that an upper limit threshold parameter of the current candidate data processing mode is the same as a lower limit threshold parameter of the adjacent candidate data processing mode.

In some embodiments, the second determining unit 1601 is further configured to: determine that Lᵢ₋₁=Uᵢ in a case that the third preset value is different from the fourth preset value; and determine that Uᵢ₋₁=Lᵢ in a case that the third preset value is the same as the fourth preset value.

In some embodiments, referring to FIG. 16, the decoder 160 may further include a second updating unit 1603, configured to: adjust threshold parameters of the candidate data processing modes to determine adjusted threshold parameters of the candidate data processing modes. When the value of the second sorting indication parameter is the fifth preset value, the second sorting indication parameter indicates a descending order of the adjusted threshold parameters; when the value of the second sorting indication parameter is the sixth preset value, the second sorting indication parameter indicates an ascending order of the adjusted threshold parameters.

In some embodiments, the second determining unit 1601 is further configured to: determine context information of the to-be-decoded syntax element; and determine the data processing mode parameter based on the context information and a preset mapping table.

In some embodiments, the second determining unit 1601 is further configured to: determine a context state of the to-be-decoded syntax element based on the context information; and determine the data processing mode parameter based on the context state and the preset mapping table. The preset mapping table is used for representing a mapping relationship between a context state and a data processing mode parameter.

In some embodiments, the second updating unit 1603 is further configured to update the preset mapping table based on the value of the to-be-encoded syntax element.

In some embodiments, the second updating unit 1603 is further configured to: decrease the data processing mode parameter in the preset mapping table in a case that the value of the to-be-decoded syntax element is a seventh preset value; increase the data processing mode parameter in the preset mapping table in a case that the value of the to-be-decoded syntax element is an eighth preset value.

In some embodiments, the second updating unit 1603 is further configured to: determine a first probability value of the target data processing mode based on the value of the to-be-decoded syntax element; and update the first probability value of the target data processing mode to determine a second probability value of the target data processing mode.

In some embodiments, the second determining unit 1601 is further configured to determine a second parameter corresponding to the target data processing mode.

The second updating unit 1603 is further configured to update the first probability value of the target data processing mode based on the second parameter and the value of the to-be-decoded syntax element, to determine the second probability value of target data processing mode.

In some embodiments, the second updating unit 1603 is further configured to: increase the first probability value of the target data processing mode in a case that the second parameter indicates first data, and the value of the to-be-decoded syntax element is a seventh preset value; decrease the first probability value of the target data processing mode in a case that the second parameter indicates first data, and the value of the to-be-decoded syntax element is an eighth preset value; or decrease the first probability value of the target data processing mode in a case that the second parameter indicates second data, and a symbol of the to-be-decoded syntax element is a seventh preset value; increase the first probability value of the target data processing mode in a case that the second parameter indicates second data, and a symbol of the to-be-decoded syntax element is an eighth preset value.

In some embodiments, the second determining unit 1601 is further configured to modify the second probability value of the target data processing mode to determine a target probability value of the target data processing mode.

In some embodiments, the second determining unit 1601 is further configured to: set the target probability value to the lower probability limit in a case that the second probability value is less than the lower probability limit; set the target probability value to the upper probability limit in a case that the second probability value is greater than the upper probability limit; set the target probability value to the second probability value in a case that the second probability value is greater than or equal to the lower probability limit and less than or equal to the upper probability limit.

It may be understood that in embodiments, the term “unit” may be a partial circuit, a partial processor, a partial program or software, or the like. Certainly, the term “unit” may be a module or may be in a non-modular form. In addition, component parts in embodiments may be integrated into one processing unit, or each of the units may exist alone physically, or two or more units may be integrated into one unit. The foregoing integrated unit may be implemented in a form of hardware, or may be implemented in a form of a software functional module.

When the integrated unit is implemented in the form of a software functional module and not sold or used as an independent product, the integrated unit may be stored in a computer-readable storage medium. Based on such an understanding, an embodiment provides a computer-readable storage medium, applied to a decoder 160. The computer-readable storage medium stores a computer program, and the computer program is executed by a second processor to implement the method according to any one of the foregoing embodiments.

Based on the structure of the decoder 160 and the computer-readable storage medium, referring to FIG. 17, FIG. 17 is a schematic diagram of a hardware structure the decoder 160 according to an embodiment of this application. As shown in FIG. 17, the decoder 160 may include a second communications interface 1701, a second memory 1702, and a second processor 1703. The components are coupled together by using a second bus system 1704. It may be understood that the second bus system 1704 is configured to implement connection and communication between these components. The second bus system 1704 may further include a power bus, a control bus, a status signal bus, and the like, in addition to a data bus. However, for clarity of description, various buses are marked as the second bus system 1704 in FIG. 17.

The second communications interface 1701 is configured to receive and transmit a signal in a process of transmitting and receiving information between the second communications interface and another external network element.

The second memory 1702 is configured to store a computer program runnable on the second processor 1703.

The second processor 1703 is configured to run the computer program to perform the following operations:
determining candidate data processing modes based on a first preset condition;
determining a data processing mode parameter corresponding to a to-be-decoded syntax element;
determining a target data processing mode based on the candidate data processing modes and the data processing mode parameter; and
decoding the to-be-decoded syntax element based on the target data processing mode to determine a value of the to-be-decoded syntax element.

Optionally, in another embodiment, the second processor 1703 is further configured to run the computer program to perform the method according to any one of the foregoing embodiments.

It may be understood that hardware functions of the second memory 1702 are similar to those of the first memory 1502, and hardware functions of the second processor 1703 are similar to those of the first processor 1503. Details are not described herein again.

An embodiment provides a decoder. In the decoder, since the candidate data processing modes meet a first preset condition of an initialization parameter, an upper limit threshold parameter, a lower limit threshold parameter or the like, in a decoding process, an optimal target decoder can be selected from the candidate data processing modes for decoding, so that a bit rate can be reduced, and coding efficiency and coding performance can be improved.

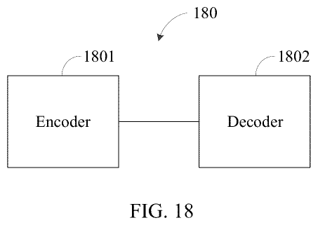

FIG. 18 is a schematic structural diagram of a coding system according to still another embodiment of this application. As shown in FIG. 18, a coding system 180 may include an encoder 1801 and a decoder 1802.

In embodiments of this application, the encoder 1801 may be the encoder according to any one of foregoing embodiments, and the decoder 1802 may be the decoder according to any one of foregoing embodiments.

It should be noted that in this application, the terminology “include”, “comprise” or any other variant is intended to cover non-exclusive inclusion, so that a process, a method, an object or an apparatus that includes a series of elements not only includes those elements, but also includes other elements that are not explicitly listed, or includes inherent elements of the process, method, object or apparatus. In the absence of further restrictions, the element limited by the sentence “including a” does not exclude the existence of other identical elements in the process, method, item or device including this element.

The sequence numbers of the embodiments of this application are only for description, and do not represent superiority or inferiority of the embodiments.

The disclosed methods provided in the several method embodiments of this application may be randomly combined with each other in the case of no conflicts, to obtain new method embodiments.

The disclosed features provided in the several product embodiments of this application may be randomly combined with each other in the case of no conflicts, to obtain new product embodiments.

The disclosed features provided in the several method or device embodiments of this application may be randomly combined with each other in the case of no conflicts, to obtain new method embodiments or device embodiments.

The foregoing descriptions are merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application shall be subject to the protection scope of the claims.

### INDUSTRIAL APPLICABILITY

In embodiments of this application, on an encoding side, candidate data processing modes is determined based on a first preset condition; a data processing mode parameter corresponding to a to-be-encoded syntax element is determined; a target data processing mode is determined based on the candidate data processing modes and the data processing mode parameter; and a value of the to-be-encoded syntax element is encoded based on the target data processing mode, and the encoded value is written into a bitstream. On a decoding side, candidate data processing modes is determined based on a first preset condition; a data processing mode parameter corresponding to a to-be-decoded syntax element is determined; a target data processing mode is determined based on the candidate data processing modes and the data processing mode parameter; and the to-be-decoded syntax element is decoded based on the target data processing mode, to determine a value of the to-be-decoded syntax element. Thus, on both the encoding side and the decoding side, candidate data processing modes are determined based on a first preset condition; then a corresponding data processing mode parameter is determined based on a to-be-encoded syntax element or a to-be-decoded syntax element, so that a target data processing mode may be determined; and finally, coding processing is performed on the syntax element based on the target data processing mode. In this way, since the candidate data processing modes meet the first preset condition, in an encoding process, an optimal target encoder can be selected from the candidate data processing modes for encoding, so that a bit rate can be reduced and coding efficiency can be improved, thereby further improving coding performance.

1. A decoding method, applied to a decoder, wherein the method comprises:
determining candidate data processing modes based on a first preset condition;
determining a data processing mode parameter corresponding to a to-be-decoded syntax element;
determining a target data processing mode based on the candidate data processing modes and the data processing mode parameter; and
decoding the to-be-decoded syntax element based on the target data processing mode to determine a value of the to-be-decoded syntax element.

2. The method according to claim 1, wherein the determining the candidate data processing modes based on the first preset condition comprises:
determining probability values of the candidate data processing modes based on the first preset condition.

3. The method according to claim 2, wherein the determining the candidate data processing modes based on the first preset condition further comprises:
determining threshold parameters of the candidate data processing modes based on the first preset condition.

4. The method according to claim 3, wherein each of the threshold parameters indicates a probability threshold of a respective candidate data processing mode, and the probability threshold comprises an upper probability limit and/or a lower probability limit.

5. The method according to claim 2, wherein the probability values of the candidate data processing modes are in a descending order.

6. The method according to claim 3, wherein the threshold parameters of the candidate data processing modes are in a descending order.

7. The method according to claim 6, wherein the method further comprises:
in the candidate data processing modes, determining that an upper probability limit of an i^{th} candidate data processing mode is equal to a threshold parameter of the i^{th} candidate data processing mode, and determining that a lower probability limit of the i^{th} candidate data processing mode is equal to a threshold parameter of an (i+1)^{th} candidate data processing mode.

8. The method according to claim 1, wherein the determining the data processing mode parameter corresponding to the to-be-decoded syntax element comprises:
determining context information of the to-be-decoded syntax element; and
determining the data processing mode parameter based on the context information and a preset mapping table.

9. The method according to claim 8, wherein the determining the data processing mode parameter based on the context information and the preset mapping table comprises:
determining a context state of the to-be-decoded syntax element based on the context information; and
determining the data processing mode parameter based on the context state and the preset mapping table,
wherein the preset mapping table is used for representing a mapping relationship between a context state and a data processing mode parameter.

10. The method according to claim 8, wherein the method further comprises:
in a case that the value of the to-be-decoded syntax element is 0, decreasing the data processing mode parameter in the preset mapping table;
in a case that the value of the to-be-decoded syntax element is 1, increasing the data processing mode parameter in the preset mapping table.

11. The method according to claim 7, wherein the method further comprises:
determining a probability value of the target data processing mode according to a value of the to-be-decoded syntax element;
modifying the probability value of the target data processing mode to determine a target probability value of the target data processing mode.

12. The method according to claim 11, wherein the modifying the probability value of the target data processing mode to determine the target probability value of the target data processing mode comprises:
in a case that the probability value is less than the lower probability limit, setting the target probability value to the lower probability limit;
in a case that the probability value is greater than the upper probability limit, setting the target probability value to the upper probability limit;
in a case that the probability value is greater than or equal to the lower probability limit and less than or equal to the upper probability limit, setting the target probability value to the probability value.

13. The method according to claim 12, wherein the method further comprises:
in a case that the probability value is less than the lower probability limit, setting the target probability value to the lower probability limit and decreasing the lower probability limit;
in a case that the probability value is greater than the upper probability limit, setting the target probability value to the upper probability limit and increasing the upper probability limit;
in a case that the probability value is greater than or equal to the lower probability limit and less than or equal to the upper probability limit, setting the target probability value to the probability value and remaining the upper probability limit and the lower probability limit unchanged.

14. The method according to claim 3, wherein values of the threshold parameters comprise: 65535, 65388, 64933, 64169, 63105, 61747, 60112, 58214, 56069, 53699, 51128, 48379, 45480, 42458, 39340, 36160, 32946, 29730, 26541, 23413, 20374, 17454, 14681, 12083, 9684, 7509, 5575, 3905, 2515, 1419, 627, 150 and 0.

15. An encoding method, applied to an encoder, wherein the method comprises:
determining candidate data processing modes based on a first preset condition;
determining a data processing mode parameter corresponding to a to-be-encoded syntax element;
determining a target data processing mode based on the candidate data processing modes and the data processing mode parameter; and
encoding a value of the to-be-encoded syntax element based on the target data processing mode, and writing the encoded value into a bitstream.

16. The method according to claim 15, wherein the determining the candidate data processing modes based on the first preset condition comprises:
determining probability values of the candidate data processing modes based on the first preset condition.

17. The method according to claim 16, wherein the determining the candidate data processing modes based on the first preset condition comprises:
determining threshold parameters of the candidate data processing modes based on the first preset condition.

18. The method according to claim 16, wherein the probability values of the candidate data processing modes are in a descending order.

19. The method according to claim 17, wherein the threshold parameters of the candidate data processing modes are in a descending order.

20. A decoder, comprising a processor configured to:
determine candidate data processing modes based on a first preset condition;
determine a data processing mode parameter corresponding to a to-be-decoded syntax element;
determine a target data processing mode based on the candidate data processing modes and the data processing mode parameter; and
decode the to-be-decoded syntax element based on the target data processing mode to determine a value of the to-be-decoded syntax element.
